(19) United States
(12) Patent Application Publication
(10) Pub. No.: US 2024/0095620 A1
(43) Pub. Date: Mar. 21, 2024

(54) MEASUREMENT APPLICATION

(71) Applicant: MiView Integrated Solutions, LLC, Carrollton, TX (US)

(72) Inventors: Luis A. URIARTE, Frisco, TX (US); Michael MAYRELL, Plano, TX (US); Sean KEARNEY, Plano, TX (US)

(73) Assignee: MiView Integrated Solutions, LLC, Carrollton, TX (US)

(21) Appl. No.: 18/523,875

(22) Filed: Nov. 29, 2023

Related U.S. Application Data
(63) Continuation-in-part of application No. 17/944,913, filed on Sep. 14, 2022.
Application No. 17/944,913 is a continuation of application No. 17/351,982, filed on Jun. 18, 2021, now Pat. No. 11,481,702.
(60) Provisional application No. 63/428,712, filed on Nov. 29, 2022.
(60) Provisional application No. 63/208,739, filed on Jun. 9, 2021.
(60) Provisional application No. 63/040,908, filed on Jun. 18, 2020.

(51) Int. Cl. G06Q 10/0631; G06Q 10/0875; G06Q 10/10; G06Q 50/08

(52) U.S. Cl. CPC G06Q 10/063114; G06Q 10/063116; G06Q 10/063118; G06Q 10/0875; G06Q 10/103; G06Q 50/08

(57) ABSTRACT

A method implements a measurement application. The method includes presenting a view to a user device. The view comprises a design image corresponding to a worksite. The design image comprises a measurement point. The method further includes receiving a measurement signal. The method further includes applying a measurement model to the measurement signal to create a measured distance corresponding to the measurement point. The method further includes applying a verification model to the measured distance to create a verification signal. The method further includes automatically updating the view to an updated view based on the verification signal. The updated view comprises an updated image. The updated image comprises the measured distance.

### CROSS REFERENCE TO RELATED APPLICATIONS

This application claims the benefit of U.S. Provisional Application 63/428,712, filed Nov. 29, 2022, which is incorporated by reference herein. This application is a continuation in part of U.S. application Ser. No. 17/944,913, filed Sep. 14, 2022, which is incorporated by reference herein. U.S. application Ser. No. 17/944,913 is a continuation of U.S. application Ser. No. 17/351,982, filed Jun. 18, 2021, which is incorporated by reference herein. U.S. application Ser. No. 17/351,982 claims the benefit of U.S. Provisional Application 63/208,739, filed Jun. 9, 2021, which is incorporated by reference herein. U.S. application Ser. No. 17/351,982 claims the benefit of U.S. Provisional Application 63/040,908, filed Jun. 18, 2020, which is incorporated by reference herein.

### BACKGROUND

Worksite information management systems track and process information about worksites. Worksite information management systems create, schedule, and track tasks and milestones. Worksite information management systems may also use points and values to track rewards for users of the system. A challenge with worksite information management systems is to track, process, and present measurement data.

### SUMMARY

In general, in one or more aspects, the disclosure relates to a method that implements a measurement application. The method includes presenting a view to a user device. The view comprises a design image corresponding to a worksite. The design image comprises a measurement point. The method further includes receiving a measurement signal. The method further includes applying a measurement model to the measurement signal to create a measured distance corresponding to the measurement point. The method further includes applying a verification model to the measured distance to create a verification signal. The method further includes automatically updating the view to an updated view based on the verification signal. The updated view comprises an updated image. The updated image comprises the measured distance.

In general, in one or more aspects, the disclosure relates to a system that implements a measurement application. The system includes at least one processor and an application executing on the at least one processor. The application performs presenting a view to a user device. The view comprises a design image corresponding to a worksite. The design image comprises a measurement point. The application further performs receiving a measurement signal. The application further performs applying a measurement model to the measurement signal to create a measured distance corresponding to the measurement point. The application further performs applying a verification model to the measured distance to create a verification signal. The application further performs automatically updating the view to an updated view based on the verification signal. The updated view comprises an updated image, wherein the updated image comprises the measured distance.

In general, in one or more aspects, the disclosure relates to a non-transitory computer readable medium with instructions that implement a measurement application. Execution of the instructions performs presenting a view to a user device. The view comprises a design image corresponding to a worksite. The design image comprises a measurement point. Execution of the instructions further performs receiving a measurement signal. Execution of the instructions further performs applying a measurement model to the measurement signal to create a measured distance corresponding to the measurement point. Execution of the instructions further performs applying a verification model to the measured distance to create a verification signal. Execution of the instructions further performs automatically updating the view to an updated view based on the verification signal. The updated view comprises an updated image, wherein the updated image comprises the measured distance.

Other aspects of the one or more embodiments will be apparent from the following description and the appended claims.

### BRIEF DESCRIPTION OF DRAWINGS

FIG. 1, FIG. 2, FIG. 3, and FIG. 4 show computing systems and components, in accordance with one or more embodiments of the disclosure.

FIG. 5 shows a method in accordance with one or more embodiments of the disclosure.

FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, and FIG. 40 show examples in accordance with one or more embodiments of the disclosure.

FIG. 41A and FIG. 41B show a computing system and network environment, in accordance with one or more embodiments of the disclosure.

Similar elements in the various figures are denoted by similar names and reference numerals. The features, elements, methods, etc., described in one figure may extend to and be used by similarly named features, elements, methods, etc., in different figures.

### DETAILED DESCRIPTION

In general, one or more embodiments are directed to a measurement application. The measurement application, in accordance with the disclosure, uses computer-based model to process signals and data to track, process, and present measurement data. As an example, systems may process design files (e.g., computer aided design (CAD) files) to generate design records, worksite records, and measurement records that identify boundaries from which measurements are taken. Users of the system may take measurements with measurement devices connected to the system. The measurements may be automatically processed to verify that work is properly completed at the worksite.

As an example, a design image may be extracted from a design file and an administrator may identify the boundaries in the design image. In an embodiment, the design image may be an overhead plan view of a structure (e.g., a house) at a worksite. The boundaries identified for the worksite may correspond to the walls of the structure. Measurement points may be placed on the design image that corresponds to the boundaries. The measurement points identify where a user should place a measurement device to take a measurement.

Continuing the example, a user of the system may use a mobile device to display the design image along with the measurement point. The user places a measurement device that may have a data connection to the mobile device at the physical location corresponding to the measurement point and triggers the measurement device to take a measurement and provide a measurement signal. The system processes the measurement signal to automatically determine the correctness of the measurement and identify whether work performed at the worksite was performed properly.

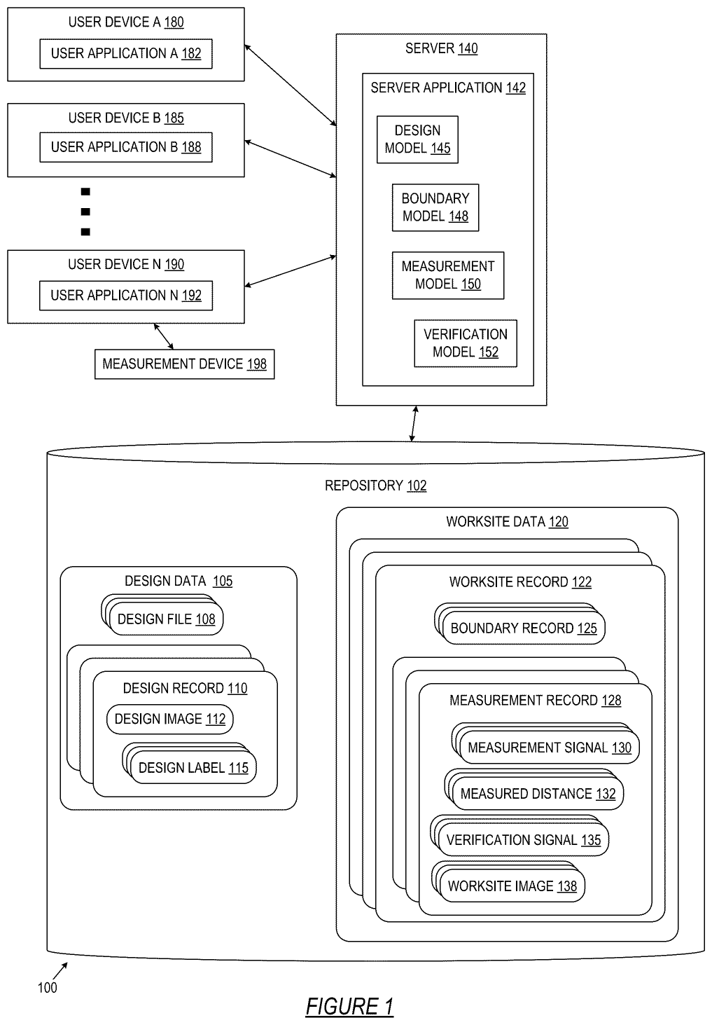

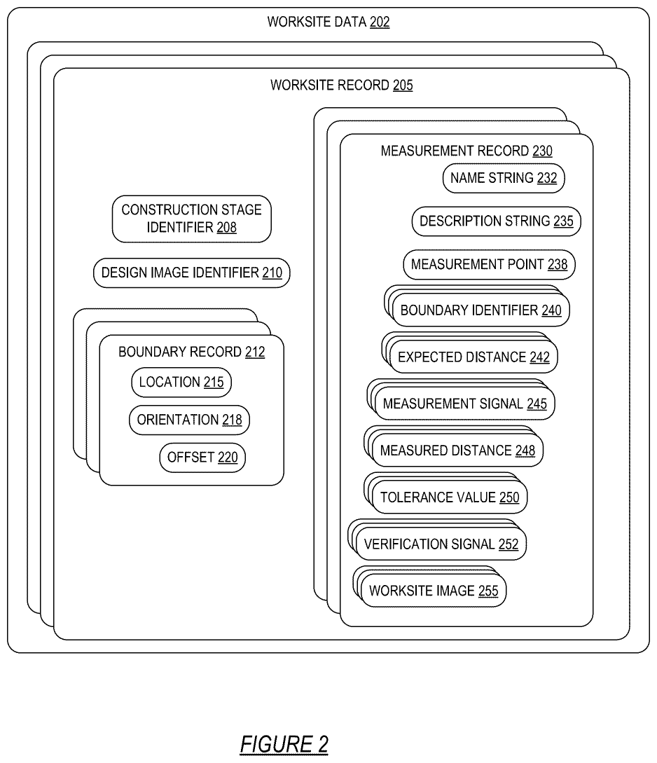

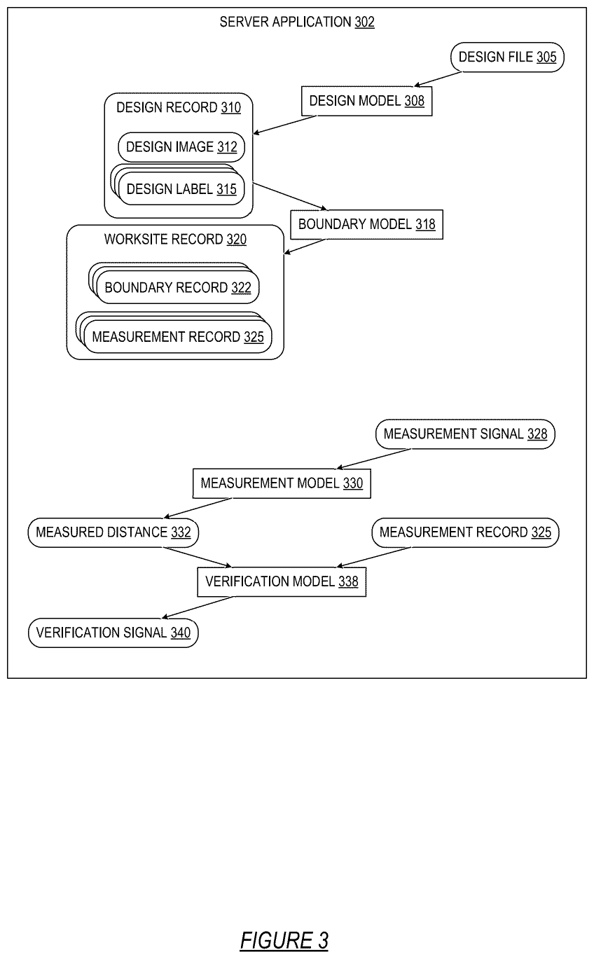

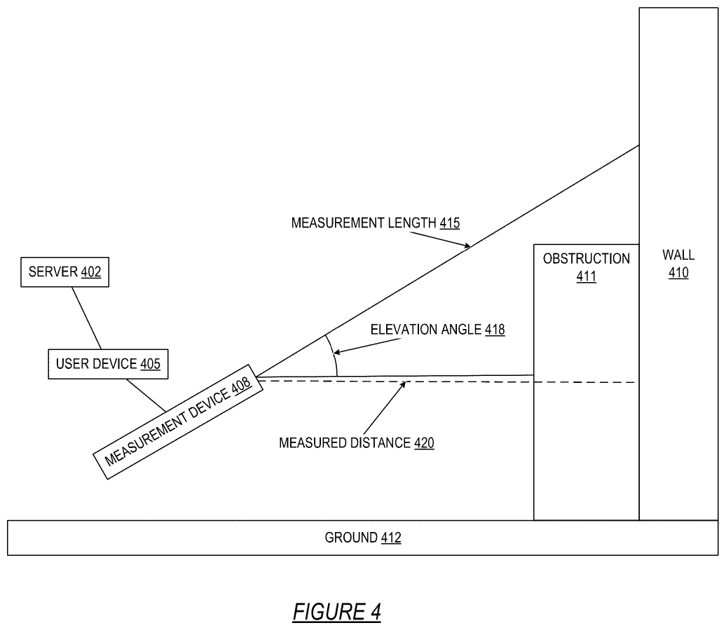

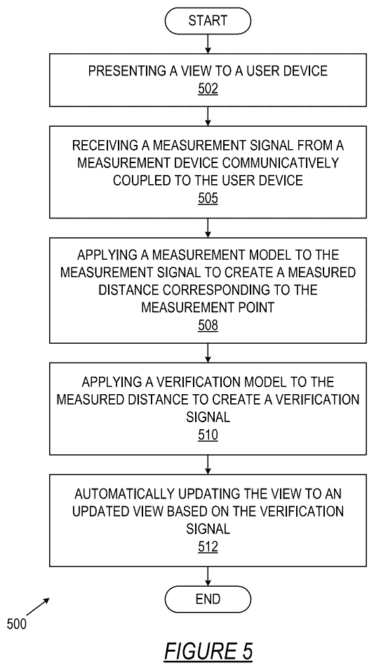

Turning to FIG. 1, the system (100) is a computing system shown in accordance with one or more embodiments that may form part of a worksite information management system. The system (100) processes messages to generate, process, and revise the data and records stored in the repository (102). The system (100) includes the repository (102), the server (140), and the user devices A (180) and B (185) through N (190), and the measurement device (198). The components of the system (100) may be connected with wired or wireless networks. Embodiments of the system (100) may use different hardware and software components to achieve similar functionality.

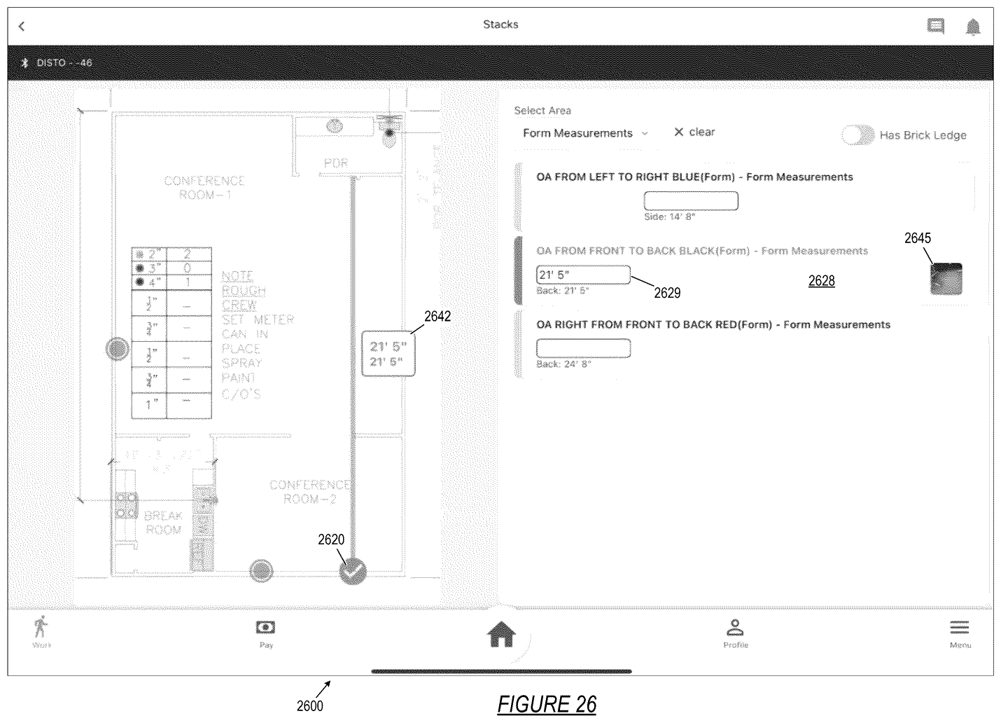

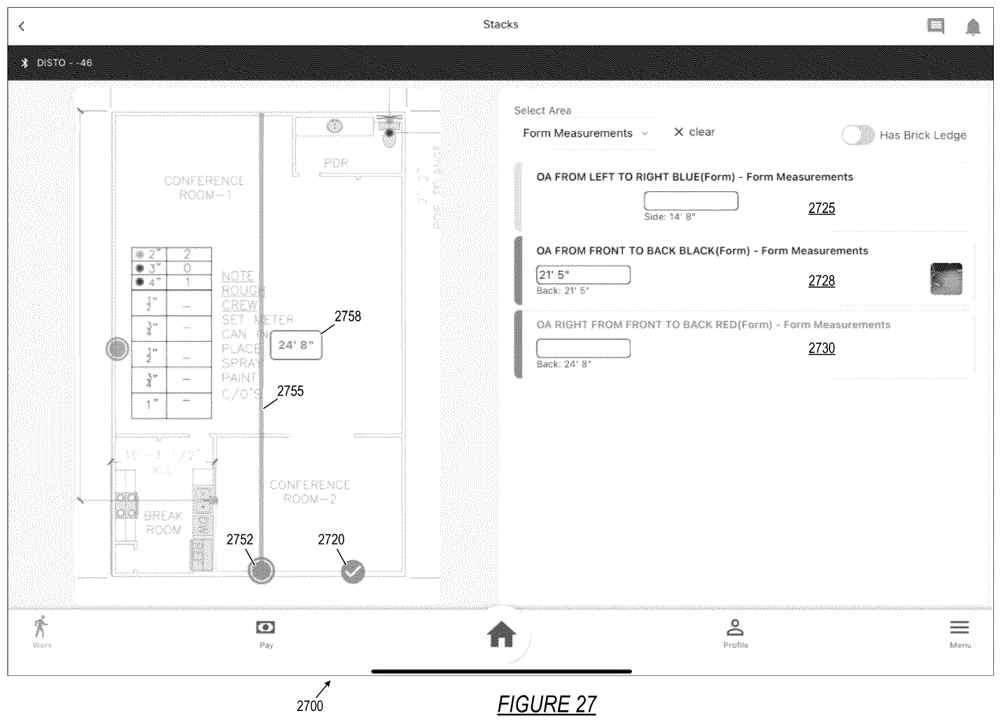

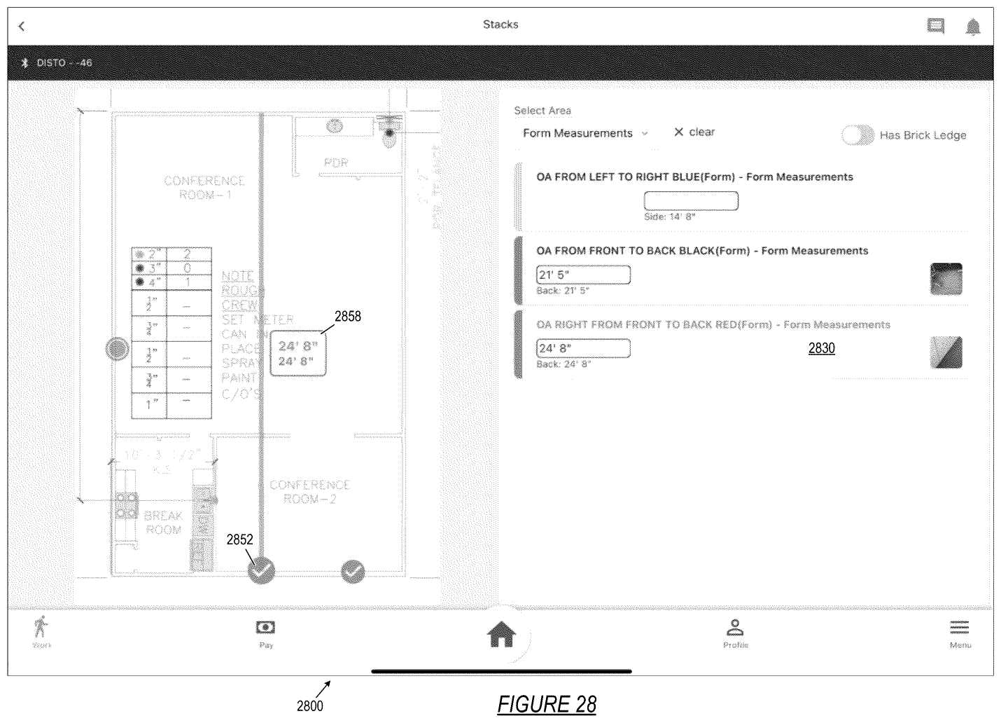

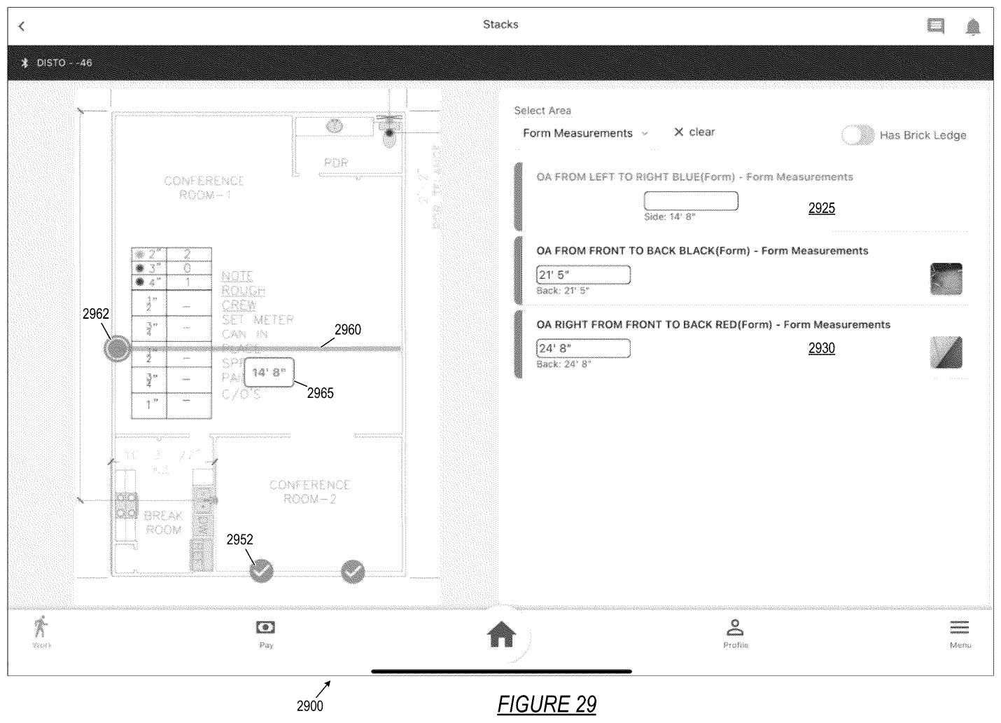

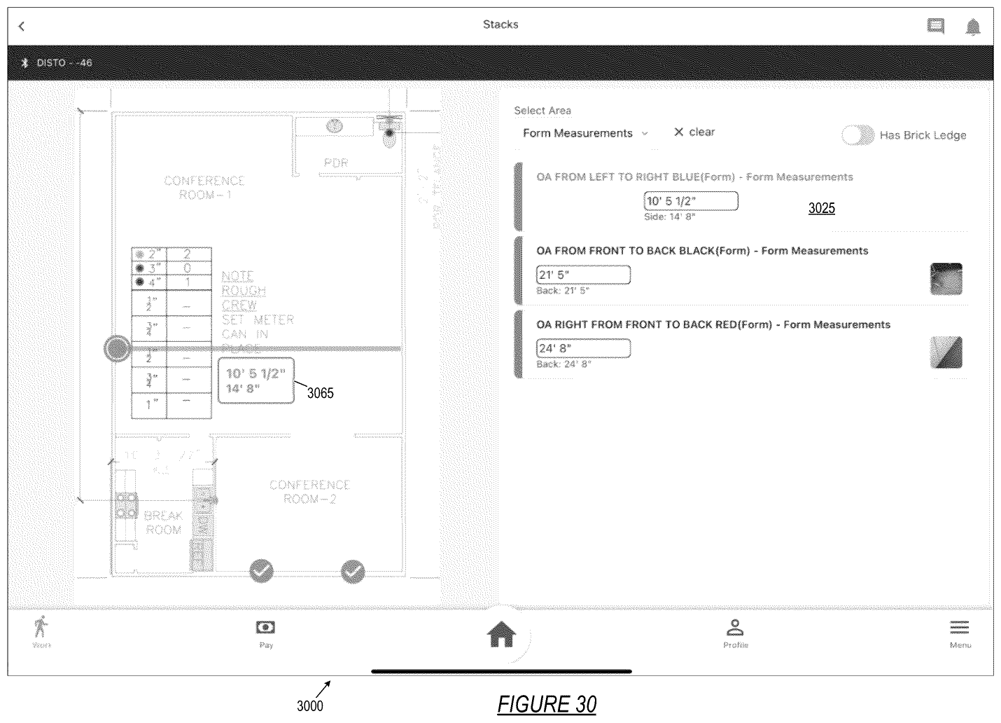

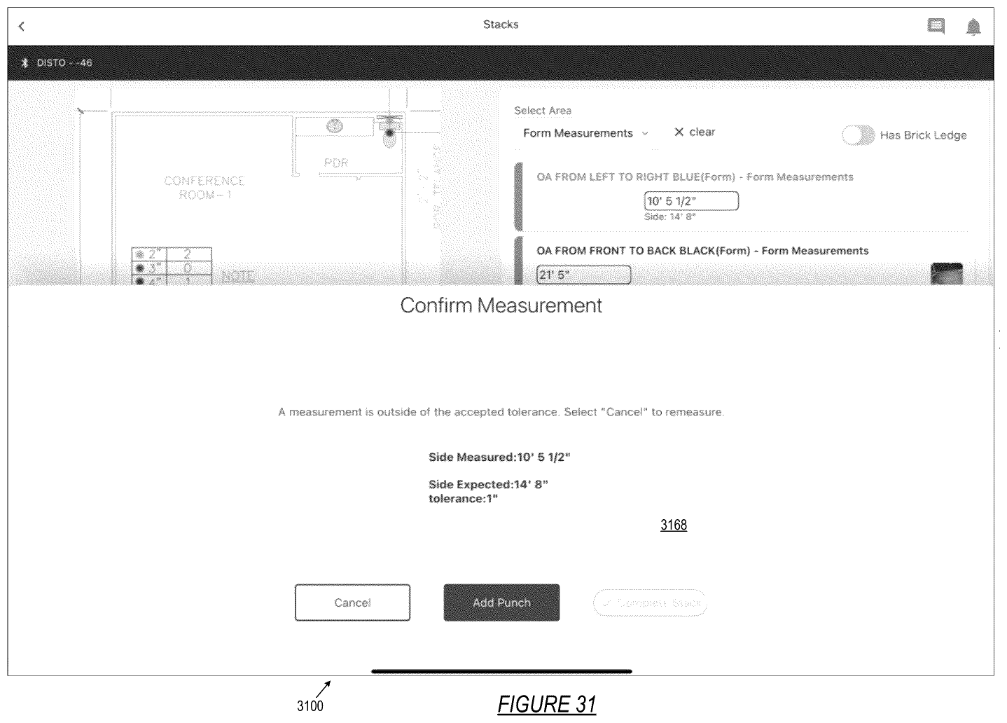

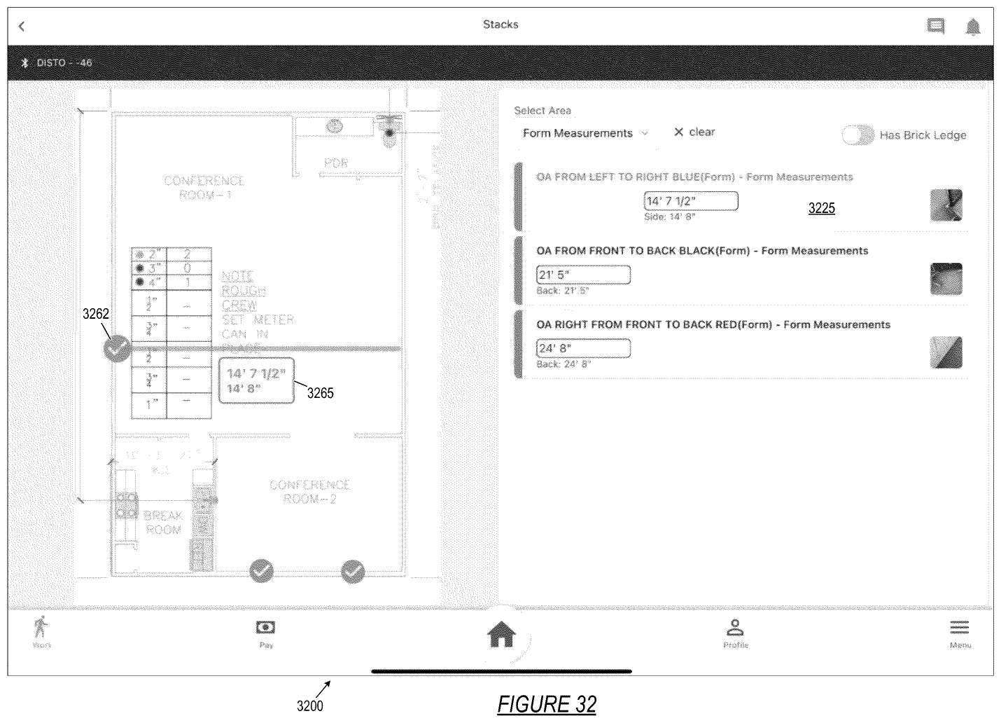

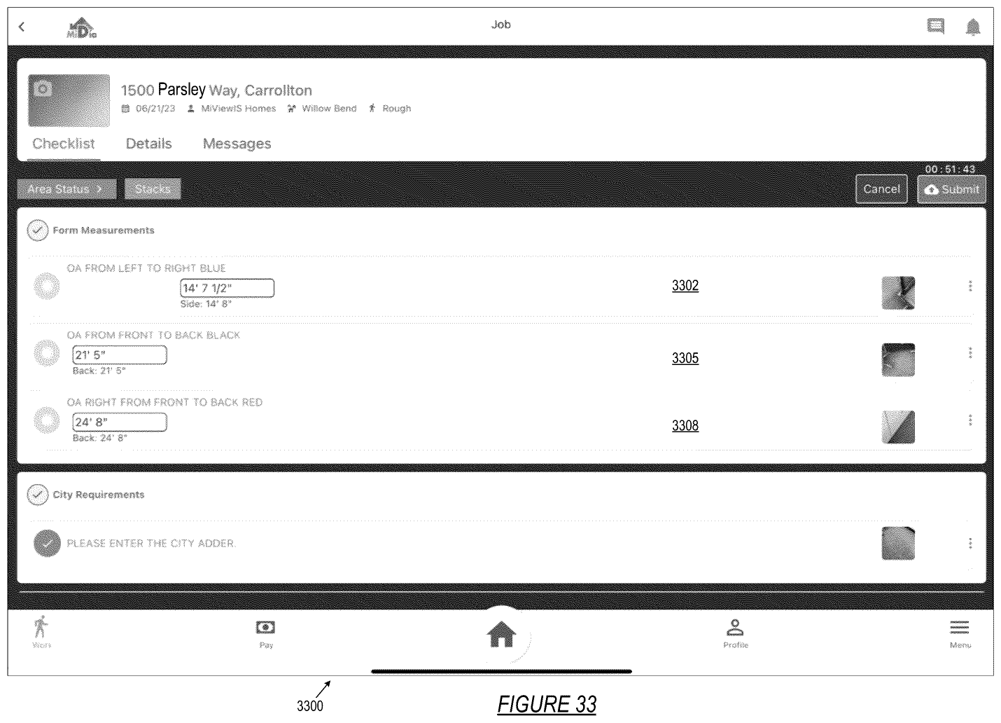

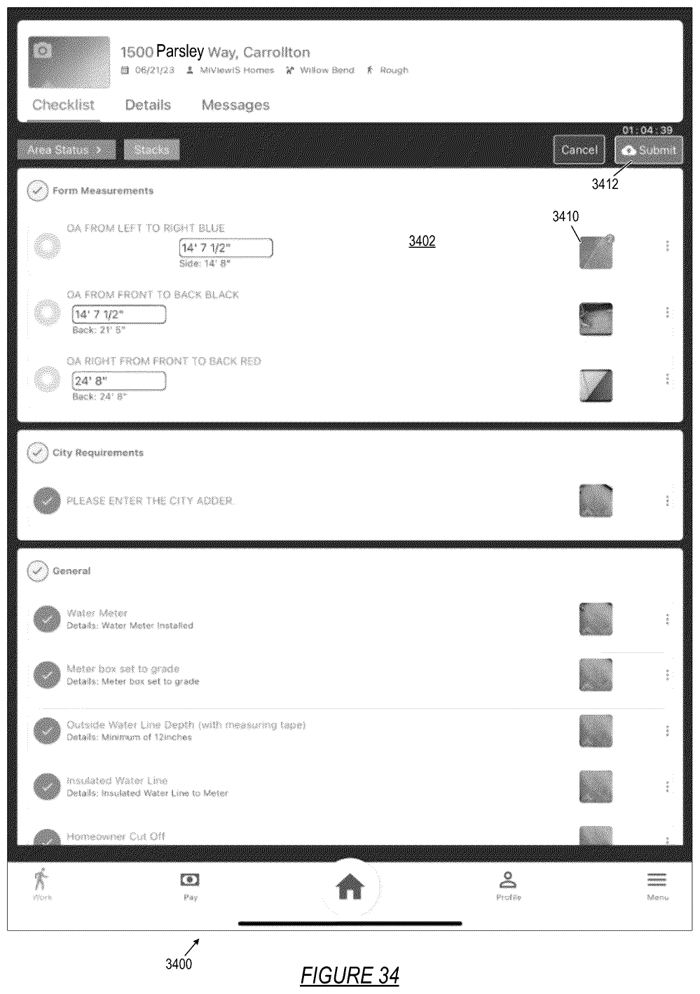

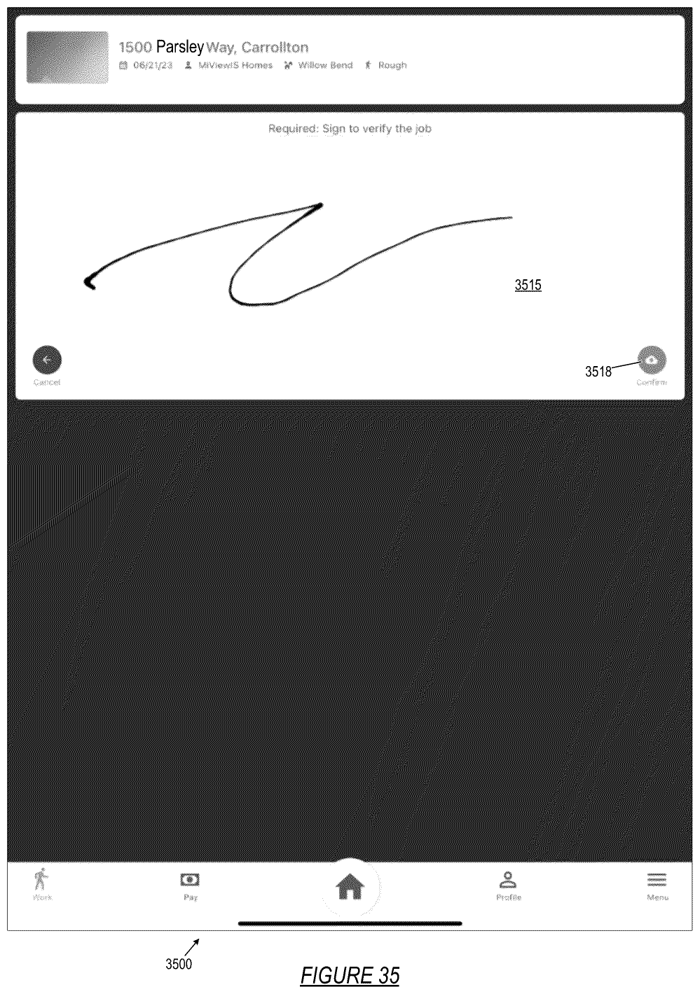

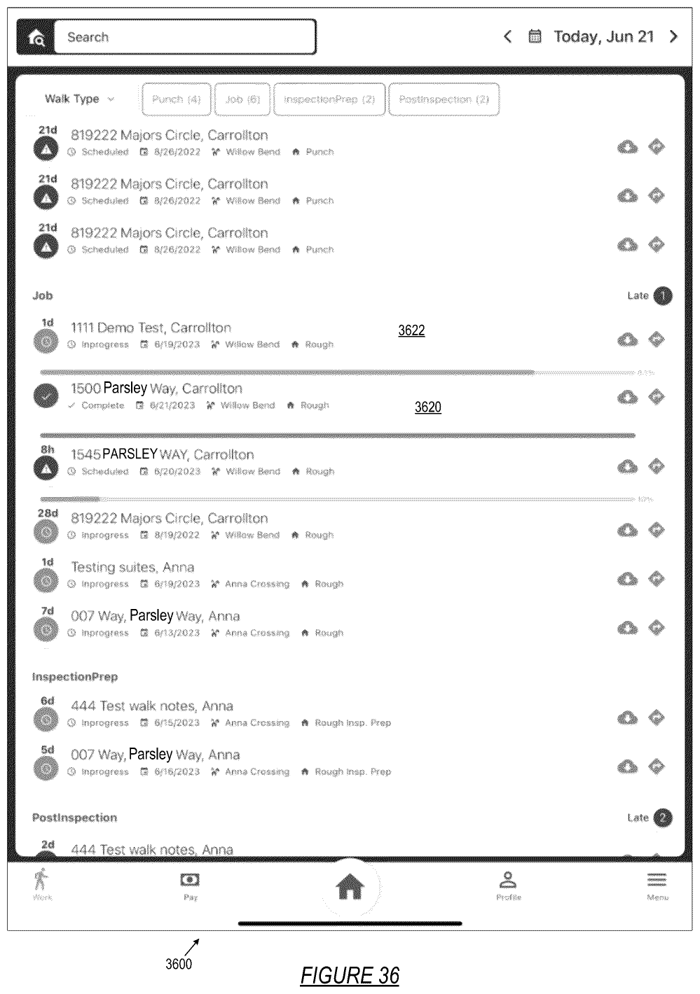

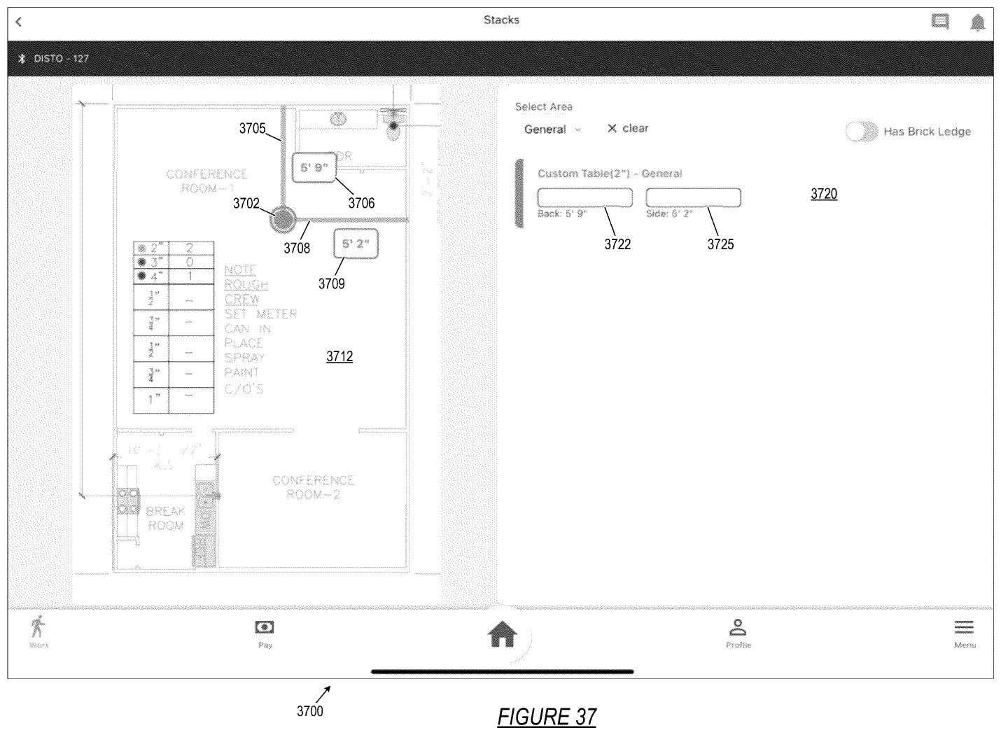

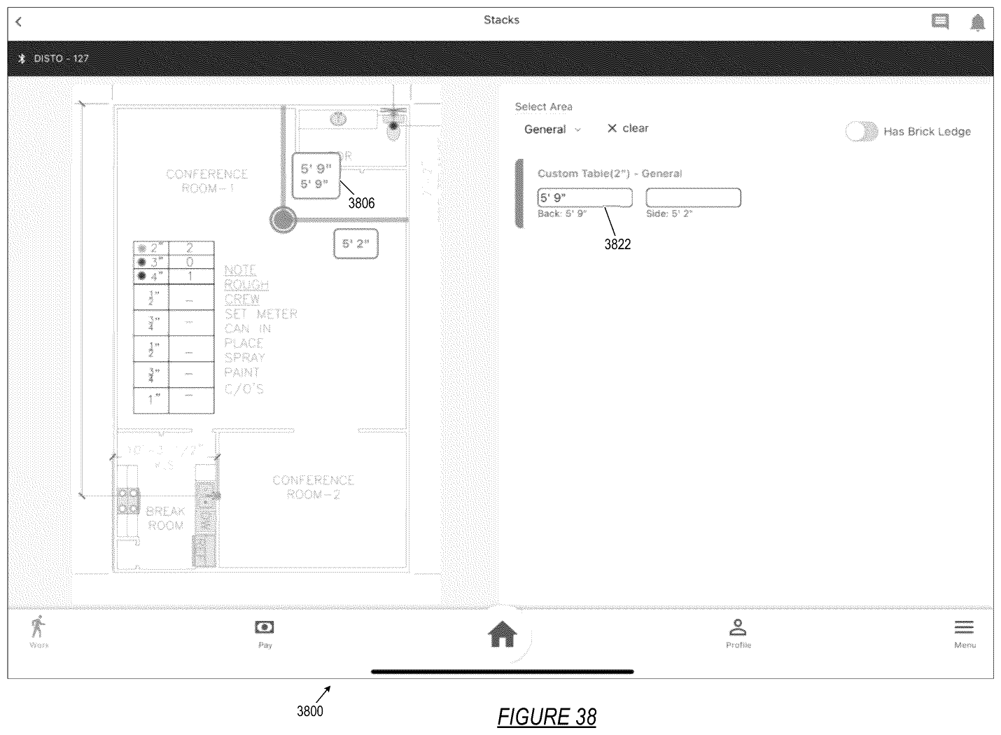

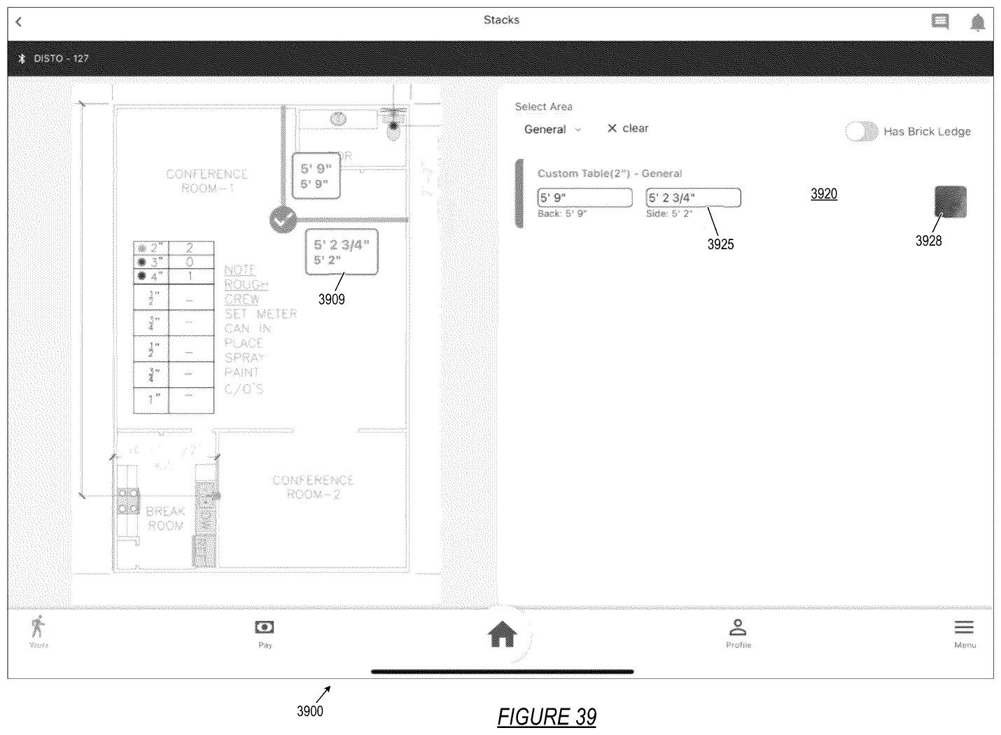

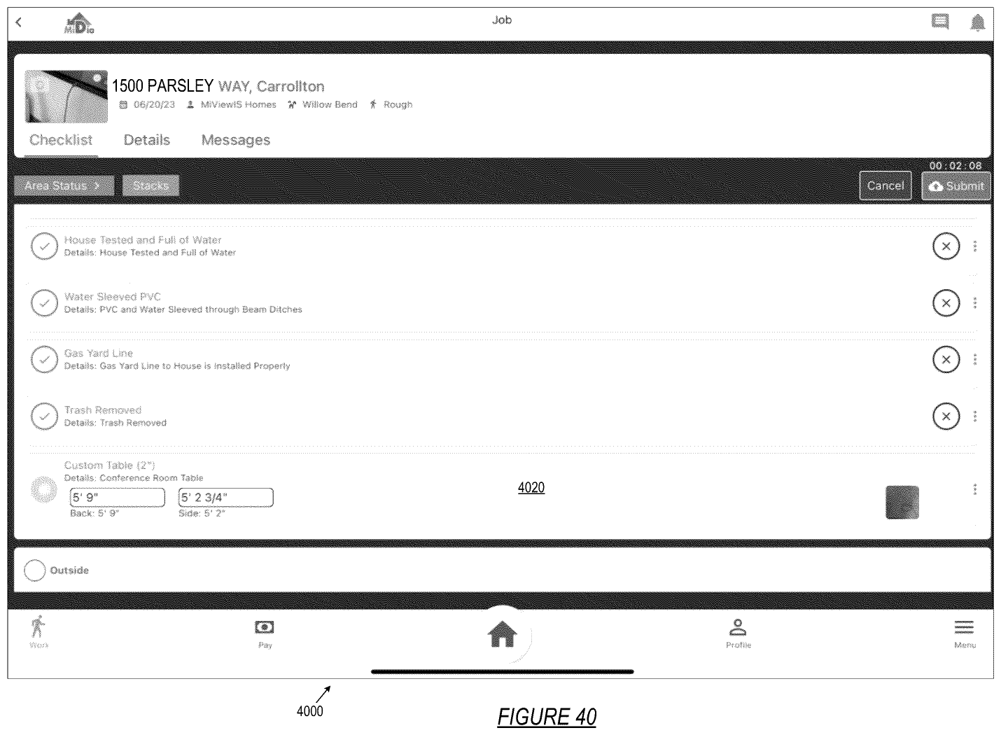

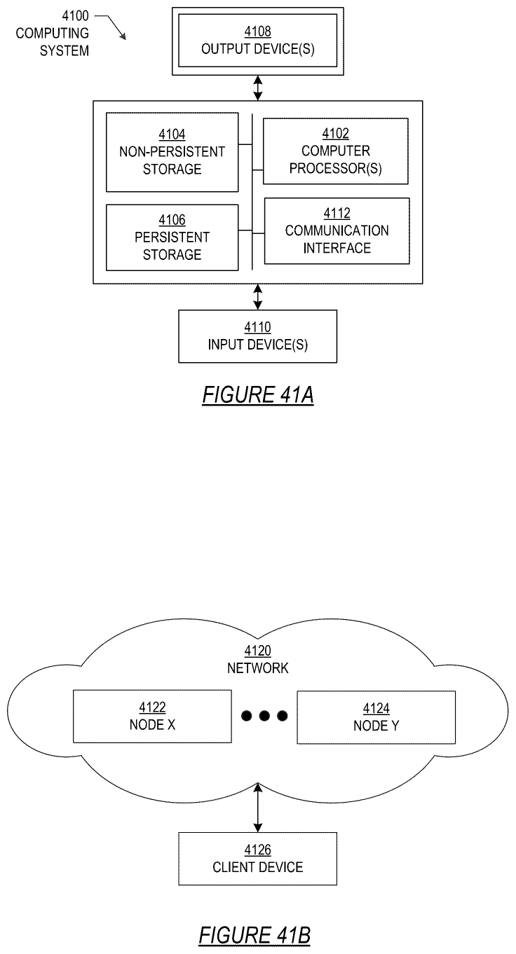

The repository (102) is a type of storage unit and/or device (e.g., a file system, database, data structure, or any other storage mechanism) for storing data and may include one or more of the computing systems (servers, desktop computers, etc.) described in FIGS. 41A and 41B. The repository (102) may include multiple different, potentially heterogeneous, storage units and/or devices. In one embodiment, the repository (102) stores data that includes the design data (105) and the worksite data (120).

The design data (105) includes information about designs. The designs may be for structures built at a worksite. The design data includes design files and design records.

The design file (108) is one of the design files of the design data (105). The design files each include information about a design. The design files store information that may be used to provide a visual display of a structure at a worksite. Types of design files may include CAD files, graphical image files, vector image files, markup language files, etc., that may be in accordance with one or more file protocols. The design file (108) may correspond to the worksite record (122). In an embodiment, the design file (108) may be in accordance with the portable document format (PDF).

The design record (110) is one of the design records of the design data (105). The design records may have a one-to-one correspondence to the design files with the design record (110) corresponding to the design file (108). The design record (110) includes the design image (112) and design labels.

The design image (112) is an image of the design of a structure. In an embodiment, the design image (112) is a graphical image that is extracted from the design file (108).

The design label (115) is one of the design labels of the design record (110). The design label (115) is a label extracted from the design file (108). In an embodiment, the design label (115) may be a text string that describes a portion of the structure in the design file (108).

The worksite data (120) includes information about a worksite. In an embodiment, a worksite is a physical location where a structure may be built in accordance with the design data (105). The worksite data (120) includes worksite records.

The worksite record (122) is one of the worksite records of the worksite data (120). In an embodiment, the worksite record corresponds to one worksite. The worksite record (122) includes boundary records and measurement records.

The boundary record (125) is one of the boundary records of the worksite record (122). The boundary record (125) includes information about the boundaries for a worksite. In an embodiment, a boundary of a boundary record may correspond to a wall of a structure at the worksite of the worksite record (122).

The measurement record (128) is one of the measurement records of the worksite record (122). The measurement record (128) includes information about measurements that may be performed at the worksite of the worksite record (122). The measurement record (128) may include measurement signals, measurement distances, verification signals, and worksite images.

The measurement signal (130) is one of the measurement signals of the measurement record (128). The measurement signal (130) is data from a measurement device (e.g., the measurement device (198)) from which the measured distance (132) is generated. In one embodiment, the measurement signal (130) may include an elevation angle and a distance.

The measurement distance (132) is one of the measurement distances of the measurement record (128). The measurement distance (132) identifies a distance measured at the worksite of the worksite record (122) and is generated from the measurement signal (130).

The verification signal (135) is one of the verification signals of the measurement record (128). The verification signal (135) identifies if the measured distance (132) is a value within an acceptable range of values that may be specified by an expected distance and a tolerance value. In an embodiment, the verification signal (135) is a binary value indicating whether verification of the measurement distance (132) was successful or unsuccessful.

The worksite image (138) is one of the worksite images of the measurement record (128). The worksite image (138) may be a graphical image that may be visually displayed to users of the system. In an embodiment, the worksite image (138) corresponds to the verification signal (135) and was captured responsive to the verification signal (135) identifying a successful verification of the measured distance (132).

Continuing with FIG. 1, the system (100) also may include the server (140). The server (140) is one or more computing systems, possibly in a distributed computing environment. An example of the server (140) may be the computing systems of FIG. 41A and FIG. 41B.

The server (140) may host and execute one or more processes, programs, applications, etc. For example, the server (140) may include the server application (142).

The server application (142) includes software or application-specific hardware programmed, when executed by at least one processor, to process the messages, records, data, and information used by the system (100). The server (140) may interact with the user devices A (180) and B (185) through N (190) to generate and process messages, records, data, and information in real time. In an embodiment, the server application (142) may include the design model (145), the boundary model (148), the measurement model (150), and the verification model (152).

The design model (145) is a computational model that may execute as part of the server application (142) on the hardware of the server (140). In an embodiment, the design model (145) is applied to the design file (108) to generate information stored in the design record (110).

The boundary model (148) is a computational model that may execute as part of the server application (142) on the hardware of the server (140). In an embodiment, the boundary model (148) is applied to the design record (110) to generate information stored in the worksite record (122), which may include the boundary record (125).

The measurement model (150) is a computational model that may execute as part of the server application (142) on the hardware of the server (140). In an embodiment, the measurement model (150) is applied to the measurement signal (130) to generate the measured distance (132).

The verification model (152) is a computational model that may execute as part of the server application (142) on the hardware of the server (140). In an embodiment, the verification model (152) is applied to the measured distance to generate the verification signal (135).

The system (100) may include one or more of the user devices A (180) and B (185) through N (190). The user devices A (180) and B (185) through N (190) are computing systems (e.g., desktops, laptops, mobile phones, tablets, etc.) that are operated by users or by automated processes (e.g., other software that may operate as part of the system (100)). The user devices A (180) and B (185) through N (190) may be used to view and manipulate the design data (105) and the worksite data (120).

In one embodiment, one or more of the user devices A (180) and B (185) through N (190) may be administrative devices that are used by administrators of the system (100), worker devices that are used by workers at worksites tracked by the system (100), trade devices that are used by supervisors of the workers, etc. The administrative devices may be used to manage the generation of the design data (105) and the worksite data (120). The worker devices may be used to capture measurement signals and work images. The trade devices may be used to review work images, capture additional work images, capture measurement signals, etc.

The measurement device (198) is a device that generates the measurement signals of the worksite data (120). In an embodiment, the measurement device (198) is a laser measurement device that uses a laser to measure distances described in the measurement signals of the worksite data (120). Different types of measurement devices may be used that provide measurement signals.

In one embodiment, one or more of the user devices A (180) and B (185) through N (190) may operate as a measurement devices. For example, the user device B (185) may be a smartphone with a camera and augmented reality (AR) software than captures and processes images to generate values for measurement signals without the use of a separate measurement device connected to the user device B (185).

Although described within the context of a client server environment with servers and user devices, aspects of the disclosure may be practiced with a single computing system and application. For example, a monolithic application may operate on a computing system to perform the same functions as one or more of the user application A (182), the server application (142), the repository (102), etc.

Turning to FIG. 2, the worksite data (202) may be used by the system (100) of FIG. 1. The worksite data (202) includes worksite records, including the worksite record (205).

The worksite record (205) includes information about a worksite. In an embodiment, the worksite record (205) includes the construction stage identifier (208), the design image identifier (210), boundary records, and measurement records.

The construction stage identifier (208) is a value that identifies the stage of construction for the worksite record (205). In an embodiment, the stages may include stages labeled as “rough in”, “box and wrap”, “top out”, “trim”, etc., which may be relevant to the plumbing trade. For different trades (e.g., electrical, heating and air, etc.) the system may be configured to use different labels for the stages of construction.

The design image identifier (210) is a value that identifies a design image for the worksite record (205). As an example, a worksite may be multiple floors and each floor may be split into multiple sections. Each floor or section may have a corresponding design image referenced by a design image identifier.

The boundary record (212) is one of the boundary records of the worksite record (205). The boundary record (212) includes information that defines and describes a boundary of a worksite used to take measurements. In an embodiment, a boundary may be displayed as a line on a design image to identify an edge from which the distance will be measured. The boundary record (212) includes the location (215), the orientation (218), and the offset (220).

The location (215) identifies the location of the boundary on the design image identified by the design image identifier (210). In an embodiment, the location (215) may be an x value or a y value that corresponds to an x or y-axis of the design image.

The orientation (218) identifies the orientation of the boundary with respect to the design image. In an embodiment, the orientation (218) may be “horizontal” or “vertical”. A horizontal orientation may correspond with a location that identifies a y-axis position. A vertical orientation may correspond with a location that identifies an x-axis. In an embodiment, the orientation (218) may identify an angle of the boundary, which may not be a horizontal or vertical line. An orientation recorded as an angle may correspond to a location recorded as a point with both X and Y axis values to position the line on the design image.

The offset (220) identifies an offset that may be used for a measurement. As an example, a boundary may have a location that corresponds to the studs of a wall without sheetrock, drywall, paneling, etc., on the wall. The offset (220) may be used to account for the thickness of the paneling applied to a wall or surface. As another example, the offset (220) may account for pipe thicknesses of a stack. A stack is a vertical assembly or column of interconnected pipes used to transport various fluids and gases within a building. Stacks may include pipes made of durable materials such as polyvinyl chloride (PVC), cast iron, or copper. Measurements for different types of building elements beyond stacks may be included.

The measurement record (230) is one of the measurement records of the worksite record (205). The measurement record (230) includes several values related to measurements that may be taken at a worksite.

The name string (232) is a string of characters to identify the measurement record (230). The name string (232) may be displayed on a user interface device to identify the measurement record (230).

The description string (235) is a string of characters that describes the measurement. The description string (235) may be written in natural language to identify a purpose for the measurement to a user of the system.

The measurement point (238) includes values that identify the location where a measurement will be taken. In an embodiment, the measurement point (238) may include X and Y axis values to identify the location of the measurement point (238) on the design image. One measurement point may correspond to multiple measurements. For example, one point may correspond to a first measurement from the measurement point to a first wall and a correspond to a second measurement point to a second wall. The first and second measurements may be at different angles relative to each other.

The boundary identifier (240) is one of the boundary identifiers for the measurement record (230). The boundary identifier (240) identifies a boundary that corresponds to the measurement point (238). The boundary identifier (240) may correspond to the boundary record (212) so that the measurement is between the measurement point (238) and the boundary identified at the location (215) with the boundary record (212).

The expected distance (242) is one of the expected distances for the measurement record (230). The expected distance (242) is a value that identifies the distance that is expected to be measured between the measurement point (238) and the boundary of the boundary identifier (240).

The measurement signal (245) is one of the measurement signals for the measurement record (230). The measurement signal (245) includes data from a measurement device that identifies the physical distance at the worksite between the location of the measurement point (238) and the boundary identified with the boundary identifier (240). In an embodiment, the measurement signal (245) includes an angle of elevation and a distance value.

The measured distance (248) is one of the measured distances for the measurement record (230). The measured distance (248) is calculated from the measurement signal (245). For example, the measured distance (248) may be calculated by multiplying the distance value from the measurement signal (245) by the cosine of the angle of elevation of the measurement signal (245).

The tolerance value (250) is one of the tolerance values for the measurement record (230). The tolerance value (250) with the expected distance (242) identify the range of acceptable values for the measured distance (248). In an embodiment, the range may be the expected distance (242) plus or minus the tolerance value (250).

The verification signal (252) is one of the verification signals for the measurement record (230). The verification signal (252) identifies whether the measured distance (248) is within the range identified with the expected distance (242) and the tolerance value (250).

The worksite image (255) is one of the worksite images of the measurement record (230). The worksite image (255) may be captured when the verification is successful to record and document the state of the worksite.

Turning to FIG. 3, the server application (302) uses the design model (308) and the boundary model (318) to process the design file (305) and the design record (310) to create the worksite record (320). The server application (302) further uses the measurement model (330) and the verification model (338) to process the measurement signal (328), the measured distance (332), and the measurement record (335) to create the verification signal (340).

The design file (305) is a file that records the design of a structure for a worksite. As an example, the design file (305) may be a PDF file that includes the design of a single family residential home. The design file (305) may be input to the design model (308) to generate at least a portion of the design record (310).

The design model (308) is a computational model that processes the design file (305). In an embodiment, the design model (308) may include one or more machine learning models that process data from the design file (305). The machine learning models of the design model (308) may output the design image (312) and a set of design labels that include the design label (315). In an embodiment, an image extracted from the design file (305) may be input to the design model (308). In an embodiment, the machine learning models of the design model may include a neural network model, which may include a large language model. In an embodiment, the output from the design model (308) may be created or double checked by a human operator of the system.

The design record (310) is a data structure that stores information extracted from the design file (305). The extracted information includes the design image (312) and the set of design labels that include the design label (315). In an embodiment, the design image (312) is an image that may be cropped from the design file (305) that shows the floor plan of a structure. In an embodiment, the design label (315) is one of a set of text strings extracted or generated from the design file (305). In an embodiment, the text labels identify measurement lengths within the floor plan of the design file (305). For example, a text label may identify the length of an exterior wall of the structure described in the design file (305).

The boundary model (318) is a computational model that processes the design record (310). In an embodiment, the boundary model (318) may include one or more machine learning models that process data from the design record (310) to generate at least a portion of the worksite record (320). In an embodiment, the boundary model (318) may generate information stored in the measurement record (325). In an embodiment, the boundary model (318) may include one or more machine learning models, which may include neural network models, which may include large language models that process information from the design record (310). For example, the design image (312) and the set of design labels may be input to a large language model with a prompt to direct the large language model to generate information stored in the boundary records and the measurement records of the worksite record (320).

The worksite record (320) is a data structure that stores information that may be generated from the design record (310). The worksite record (320) includes a set of boundary records including the boundary record (322) and a set of measurement records including the measurement record (325). The boundary record (322) includes information about a boundary for a worksite, which may correspond to a wall of a structure at the worksite. The measurement record (325) includes information about measurements that may be performed at the worksite and may include measurement distances extracted from the design record (310).

The measurement signal (328) is data from a measurement device that corresponds to the measurement record (325). The measurement signal (328) is received by the server application (302) and input to the measurement model (330).

The measurement model (330) is a computational model that processes the measurement signal to generate the measured distance. In an embodiment, the measurement model (330) may include a machine learning model that processes the measurement signal. In an embodiment, the measurement model (330) is a mathematical model that computes the measured distance (332) from the measurement signal (328).

The measured distance (332) is a distance generated from the measurement signal (328) by the measurement model (330). The measured distance (332) corresponds to a distance between a measurement point, identified in the measurement record (325), and a boundary described by the boundary record (322) and identified in the measurement record (325). The measured distance (332) and the measurement record (325) are input to the verification model (338). The measurement record (325) includes an expected distance and a tolerance value for verification of the measured distance (332).

The verification model (338) is a computational model that processes the measured distance (332) with the expected distance and the tolerance value from the measurement record (325) to generate the verification signal (340). In an embodiment, verification may be computed mathematically by determining a range from the expected distance plus or minus the tolerance value and then determining whether the measured distance falls within the range.

The verification signal (340) identifies whether the measured distance (332) is within the range identified by the expected distance and the tolerance value. In an embodiment, the verification signal (340) may be a binary value with “1” for verified (within range) and “0” for not verified (outside of range).

Turning to FIG. 4, usage of the measurement device (408) is illustrated. The measurement device (408) is communicatively connected to the user device (405), which is communicatively connected to the server (402). In one embodiment, the measurement device (408) may connect to the server directly through a network without the user device (405). The connections may be wired or wireless using one or more networks and protocols. The measurement device (408) may be a laser measurement device that measures distances using beams of light.

A clear path between the measurement device (408) and the wall (410) is unavailable due to the obstruction (411) (e.g., a shelf, a television, a counter, etc.). Measuring the distance between the measurement device (408) and the obstruction (411) would not provide an accurate measurement. The user elevates the angle of the measurement device (408) to get a clear path between the measurement device (408) and the wall (410).

Upon activation by the user, the measurement device (408) measures the distance between the measurement device (408) and the wall (410), which stands up from the ground (412), over the obstruction (411). The measurement device (408) generates a measurement signal that includes values for the measurement length (415) and the elevation angle (418).

The value of the measurement length (415) represents the distance measured between the measurement device (408) and the wall (410). The value of the elevation angle (418) indicates the vertical inclination of the measurement device (408) with respect to the ground (412).

The user device receives the measurement signal from the measurement device and may transmit the measurement signal to the server (402). The measured distance is then calculated from the measurement length (415) and the elevation angle (418) of the measurement signal. The measured distance (420) may be calculated by the user device (405) or the server (402).

Turning to FIG. 5, the method (500) processes measurement information. As noted in the brief description of the drawings, the method (500) may be performed using the systems described in the other figures.

At Step 502, the method (500) includes presenting a view to a user device. The view may be presented by transmitting code for the view from a server to a user device, which may display the view. The view includes a design image corresponding to a worksite. The design image includes a measurement point. In an embodiment, the user device may be a mobile device, such as a smartphone or tablet.

At Step 505, the method (500) includes receiving a measurement signal. In an embodiment, the measurement signal may be a message with text in accordance with a protocol, which may be the JavaScript object notation (JSON) protocol. For example, the measurement signal may be the text “{“measurement length”: “10.325”, “elevation angle”: “5.389” }” to indicate that the length is measured at 10.325 feet with an elevation angle of 5.389 degrees.

The measurement signal may be generated by a user device or received by the user device from a separate measurement device. For example, an images of a shower may be captured by a smartphone with augmented reality software that calculates the distance from the floor of the shower to the shower head. As another example, a laser measurement device may provide the measurement signal to a user device upon measuring the distance from the location of the laser measurement device to a wall at the worksite.

At Step 508, the method (500) includes applying a measurement model to the measurement signal to create a measured distance corresponding to the measurement point. In an embodiment, the measurement model may extract the measurement length and elevation angle from the measurement signal and then calculate the measured distance. For example, the measured distance may be calculated by multiplying the measurement length by the cosine of the elevation angle.

At Step 510, the method (500) includes applying a verification model to the measured distance to create a verification signal. In an embodiment, the verification model may identify a range for the measured distance from an expected distance and a tolerance value from a measurement record. The range may be calculated by adding the tolerance value to the expected distance and then subtracting the tolerance value from the expected distance to identify the bounds of the range. When the measured distance is within the range, the verification signal may be true or “1” to indicate that the verification succeeded. When the measured distance is less than the minimum value of the range or greater than the maximum value of the range, then the verification signal may be false or

At Step 512, the method (500) includes automatically updating the view to an updated view based on the verification signal. The updated view includes an updated image. The updated image includes the measured distance. In an embodiment, the measured distance may be located on the updated image between a boundary and the measurement point to display the distance between the measurement point and the boundary. The color of the measured distance may indicate whether the verification was successful. For example, green or black may be used to indicate a successful verification and red may be used to indicate the verification was unsuccessful. The color may be applied to the font or to the background.

In an embodiment, the method (500) may further include automatically presenting a camera view responsive to the verification signal indicating a successful verification. The camera view may be presented by transmitting a signal to the user device to display the camera view. In response, the user device may display a live view from a camera of the user device, which may include watermarks and overlays. The watermarks may identify one or more organizations related to the worksite. The overlays may include information about the worksite, including the address, builder, community, user of the device, etc.

In an embodiment, the method (500) may further include receiving a worksite image captured with a user device. The worksite image is captured at the worksite and may include at least one watermark embedded within the worksite image, at least one highlight overlaid onto the worksite image, and worksite text overlaid onto the worksite image. The highlight may be formed as a line drawing on the image to highlight and identify an item at the worksite and captured in the image. For example, the item may be a stack that has been installed at the worksite.

In an embodiment, the method (500) may further include presenting a worksite thumbnail generated from the worksite image in the updated view. Presenting the worksite thumbnail may include compressing the image to a reduced size, resolution, etc., and transmitting the worksite thumbnail to the user device, which may display the worksite thumbnail.

In an embodiment, the method (500) may further include automatically presenting a confirmation view responsive to the verification signal indicating an unsuccessful verification. The confirmation view may provide options to override the verification or to retry measuring the distance. In an embodiment, the confirmation view may include a user interface element to add a punch. In an embodiment, a punch identifies additional work to be performed at the worksite, which may be done to correct previous work that was not sufficiently performed. Information about the punch, including the worksite, the location at the worksite, a description of the work to be performed, etc., may be stored in a data structure maintained by the system.

Selecting to add a punch may bring up another dialog box to collect information from the user to identify additional work to be done at the worksite. The additional work may correct an item at the worksite. Once performed, the measured distance may be within the range of the expected distance and the tolerance value.

In an embodiment, the method (500) may further include receiving a second measurement signal from a measurement device. The second measurement signal may correspond to a measurement that is at a different angle or to a different wall as compared to the first measurement signal. For example, the first measurement may be from a measurement point to a back wall and the second measurement may be from the measurement point to a side wall. In one embodiment, the back wall and the side wall may be orthogonal (at a right angle) to each other so that he first and second measurement signals may correspond to orthogonal directions.

In an embodiment, the method (500) may further include applying the measurement model to the second measurement signal to generate a second measured distance. The measurement model may adjust the measurement length to take into account the elevation angle used by the device generating the measurement signal.

In an embodiment, the method (500) may further include applying a second verification model to the second measured distance to generate a second verification signal corresponding to the measurement point. The second verification model may use a different expected distance and tolerance value for the range for the second measured distance.

In an embodiment, the method (500) may further include automatically updating the view to the updated view. The updated view includes the measured distance and the second measured distance. Each of the measured distances may be color coded to identify the verification of the measured distances.

In an embodiment, the image may include a measurement point that corresponds to an expected distance. Multiple measurement points may be located on an image and each measurement point may identify multiple measurements to be taken at the measurement points. Measurements to different boundaries or walls may be taken from the same measurement point. For example, orthogonal measurements may be taken from one measurement point.

In an embodiment, the method (500) may further include presenting the updated view with the updated image. The updated image may include an expected distance and the measured distance.

In an embodiment, the verification signal may indicate that the measured distance is within a tolerance value of an expected distance. For example, when the verification is successful, the verification signal may include a value of “1”.

In an embodiment, the method (500) may further include presenting a measurement item of a measurement checklist. The measurement item is automatically updated based on the verification signal. The measurement item is presented with a worksite thumbnail generated from a worksite image captured at the worksite. The measurement checklist includes multiple measurement items that identify measurements to be performed at the worksite.

In an embodiment, the method (500) may further include presenting a worksite item of a worksite checklist. The worksite item and worksite checklist may also be referred to as a task item and a task checklist. The worksite checklist includes a list of worksite items that may identify tasks to be performed at a worksite.

In an embodiment, the method (500) may further include applying a completion model to the worksite item to generate a completion signal. The completion model may determine that the worksite item has been completed with recorded measurements and images.

In an embodiment, the method (500) may further include automatically updating the worksite item to an updated worksite item based on the completion signal. The updated worksite item may have a different colored icon or symbol than the worksite item to visually illustrate that the work for the worksite item has been completed.

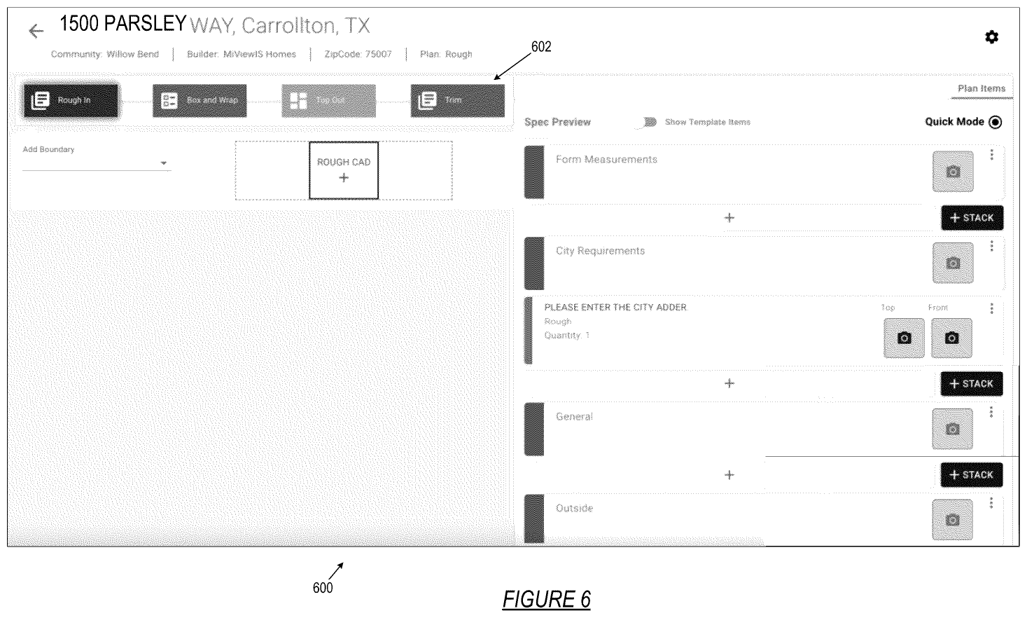

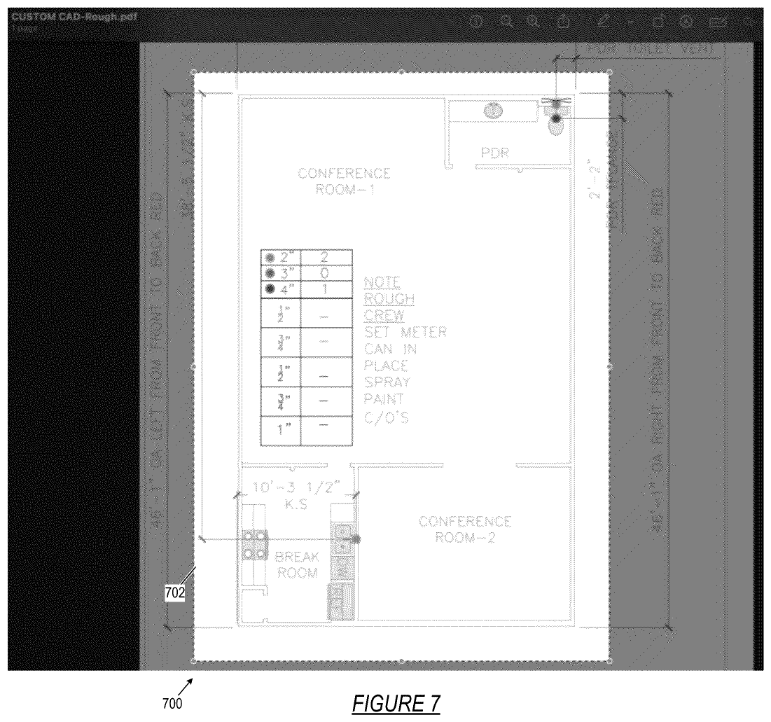

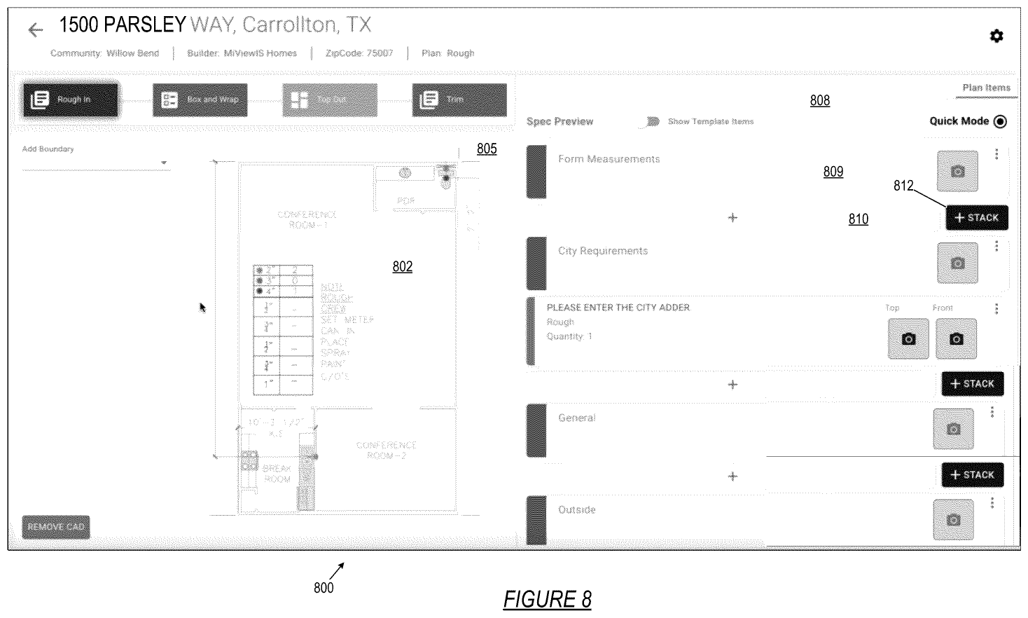

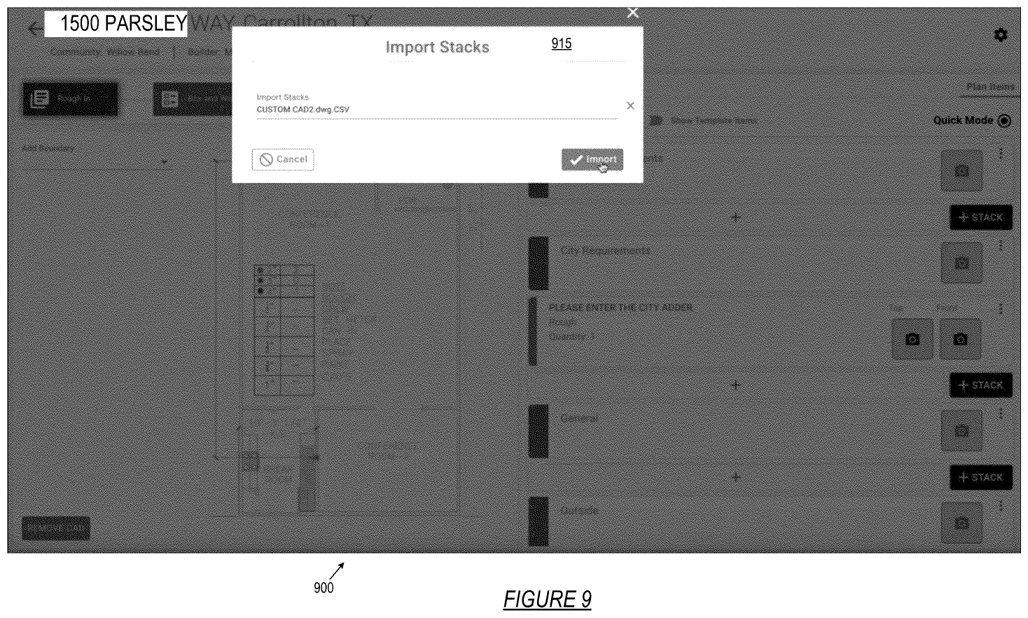

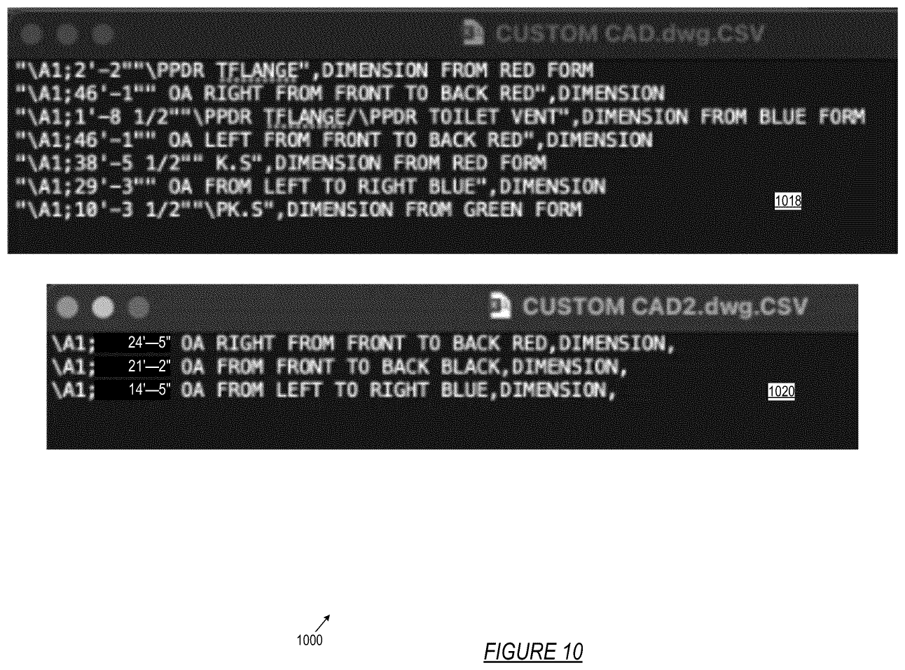

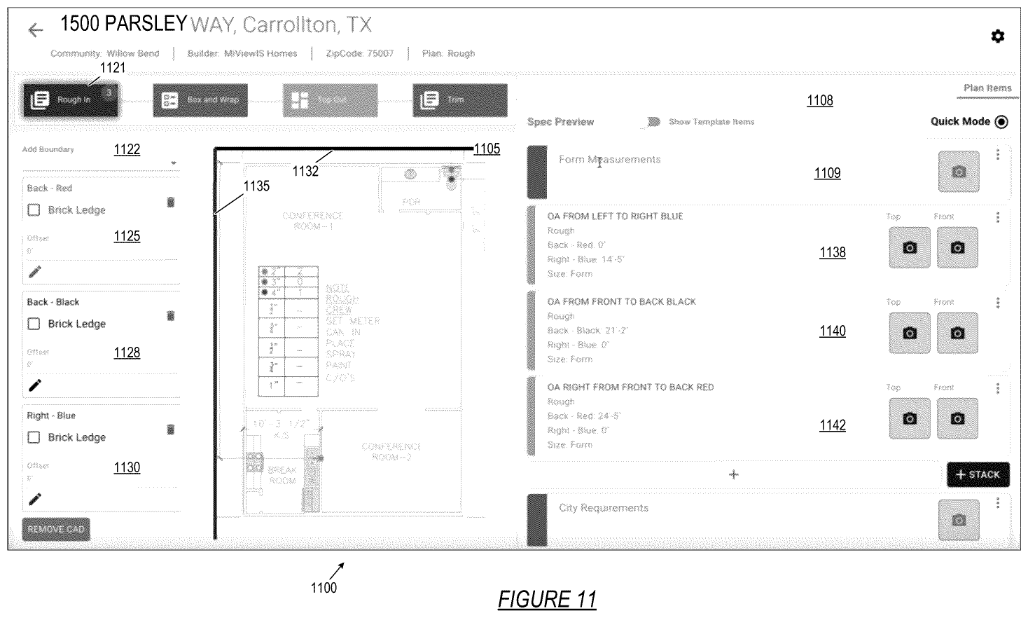

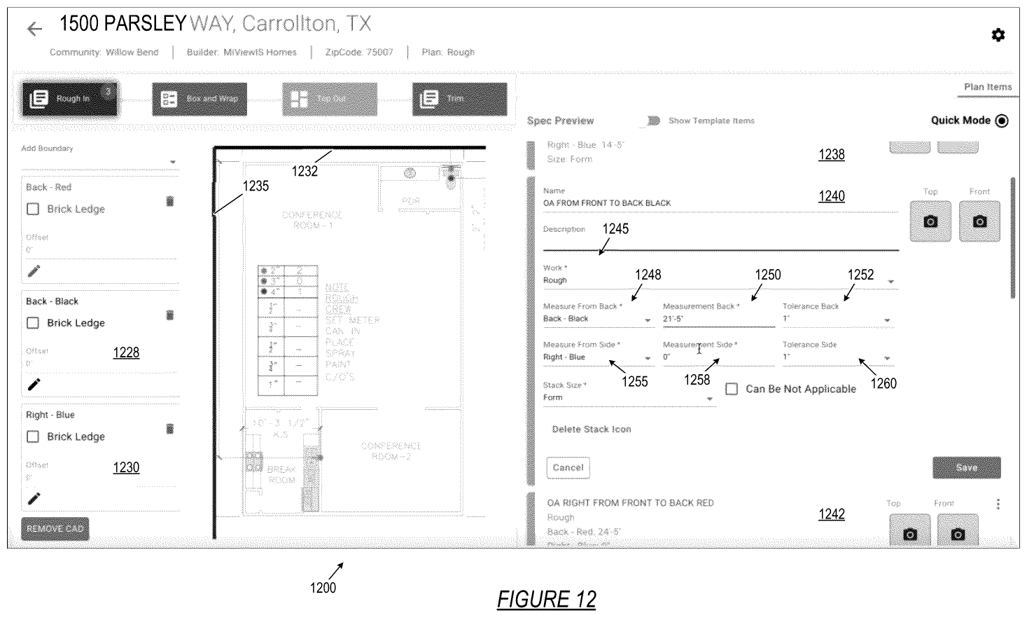

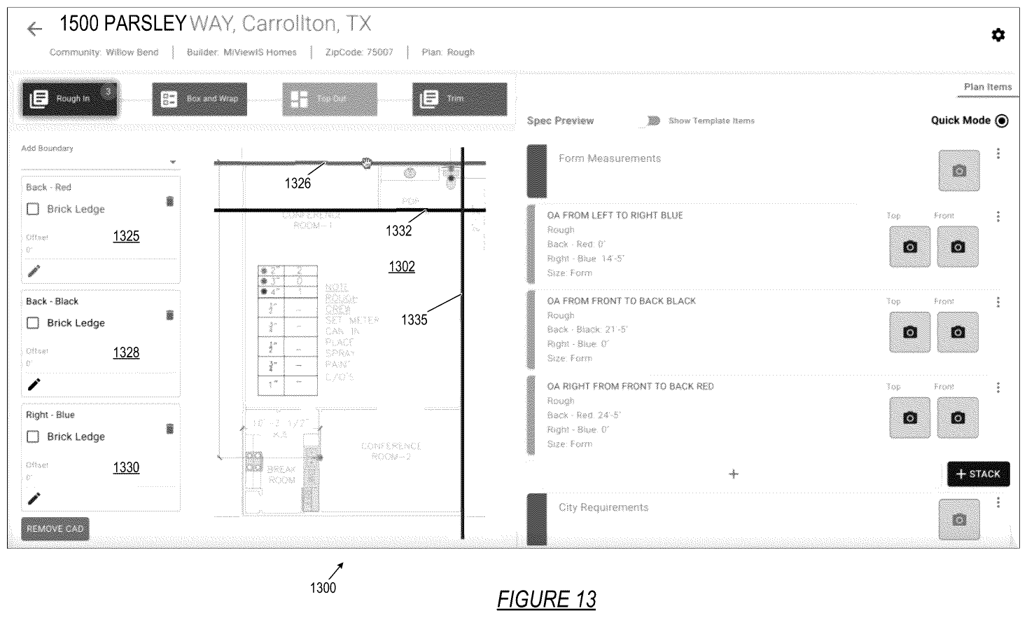

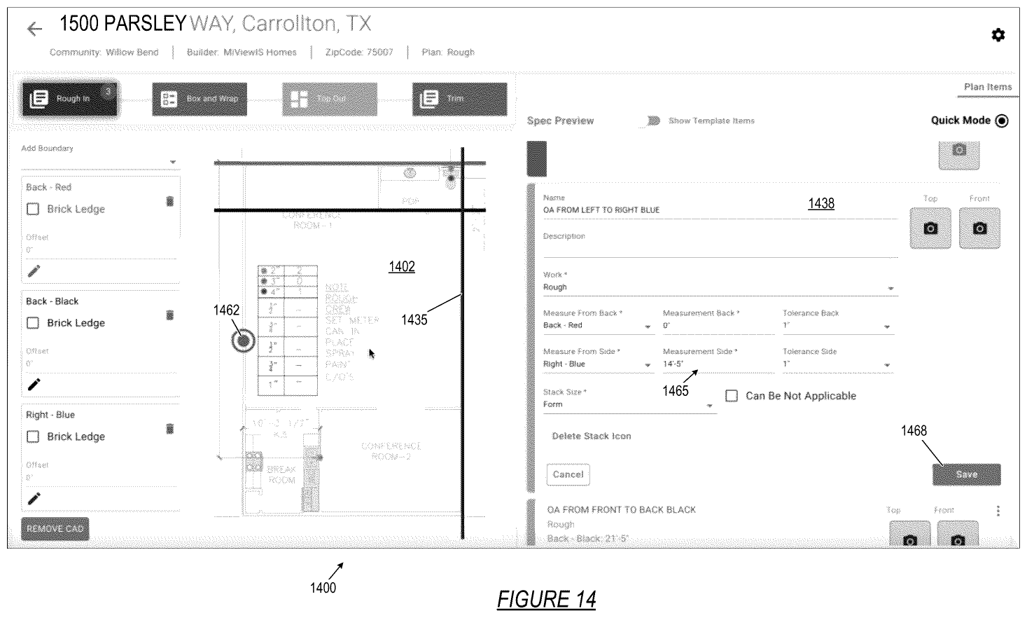

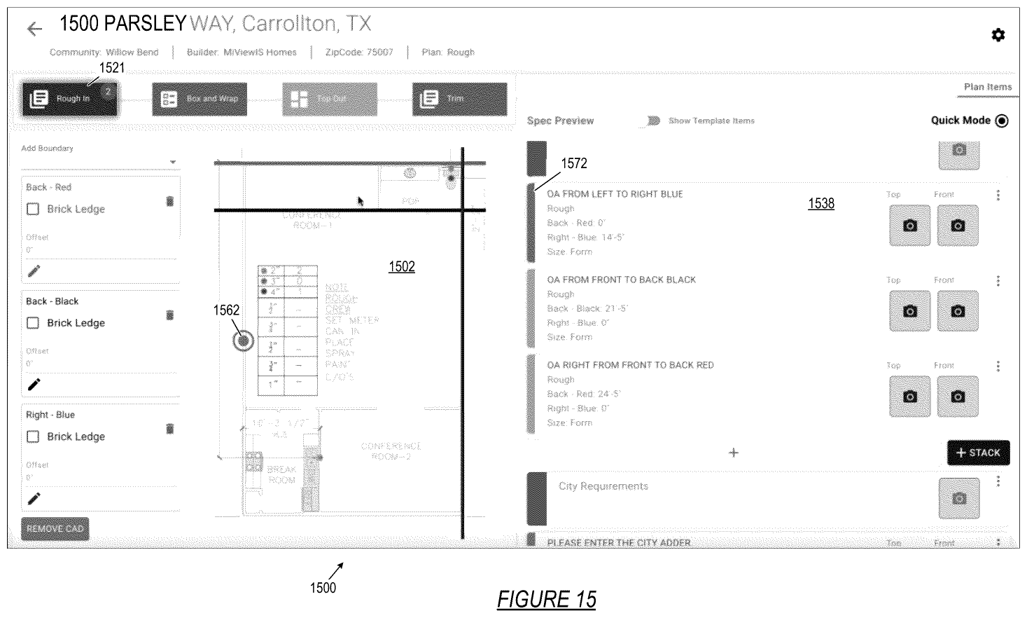

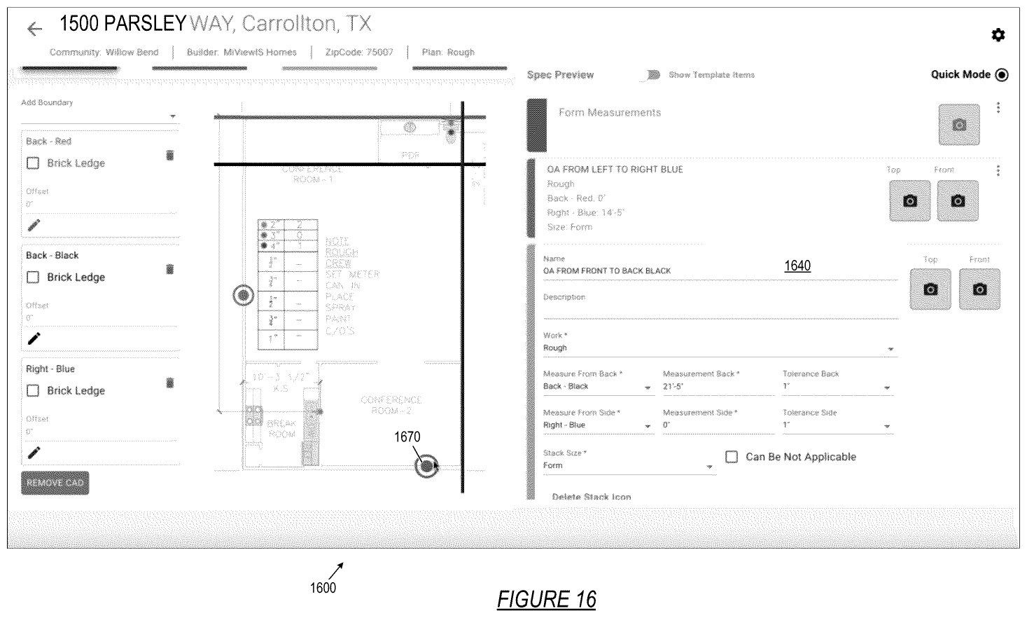

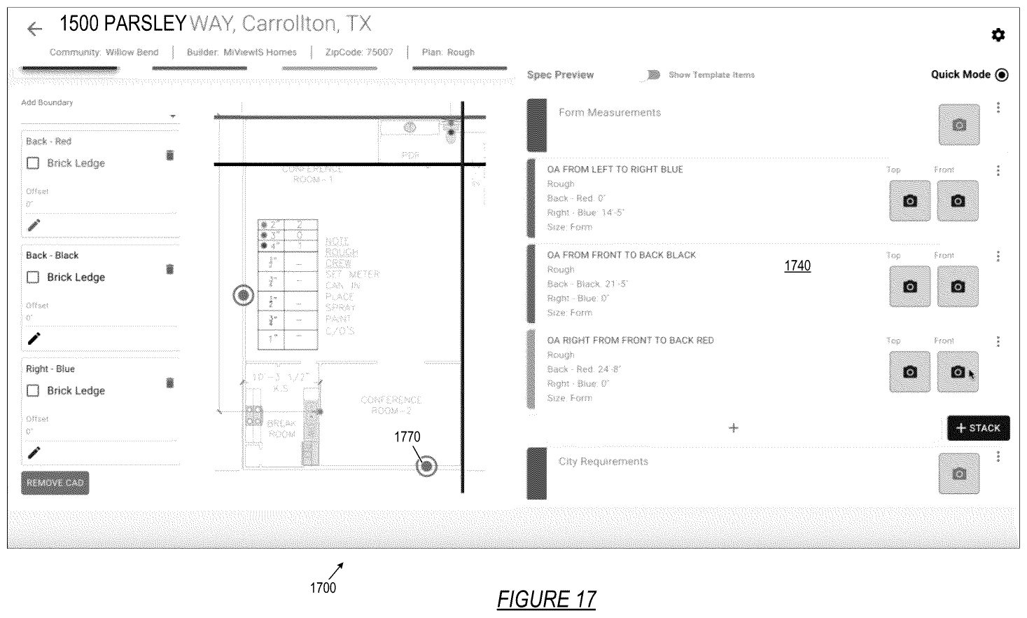

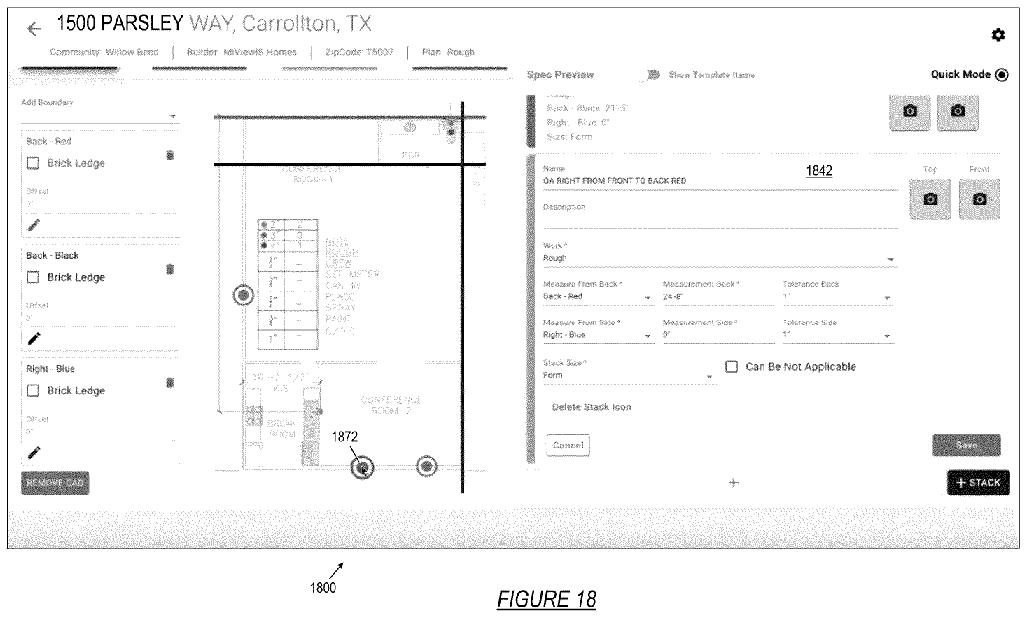

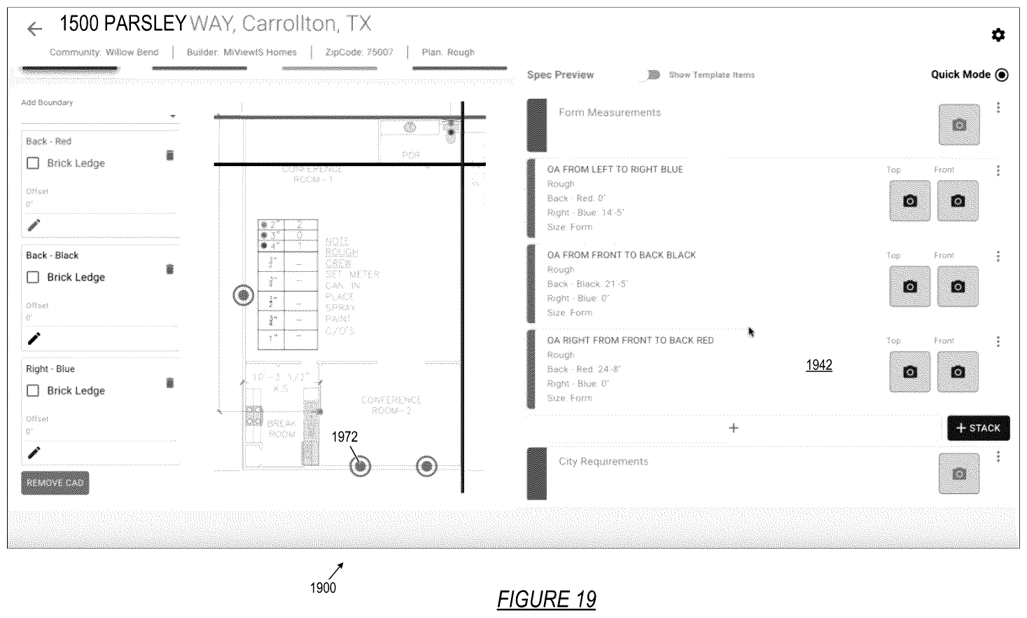

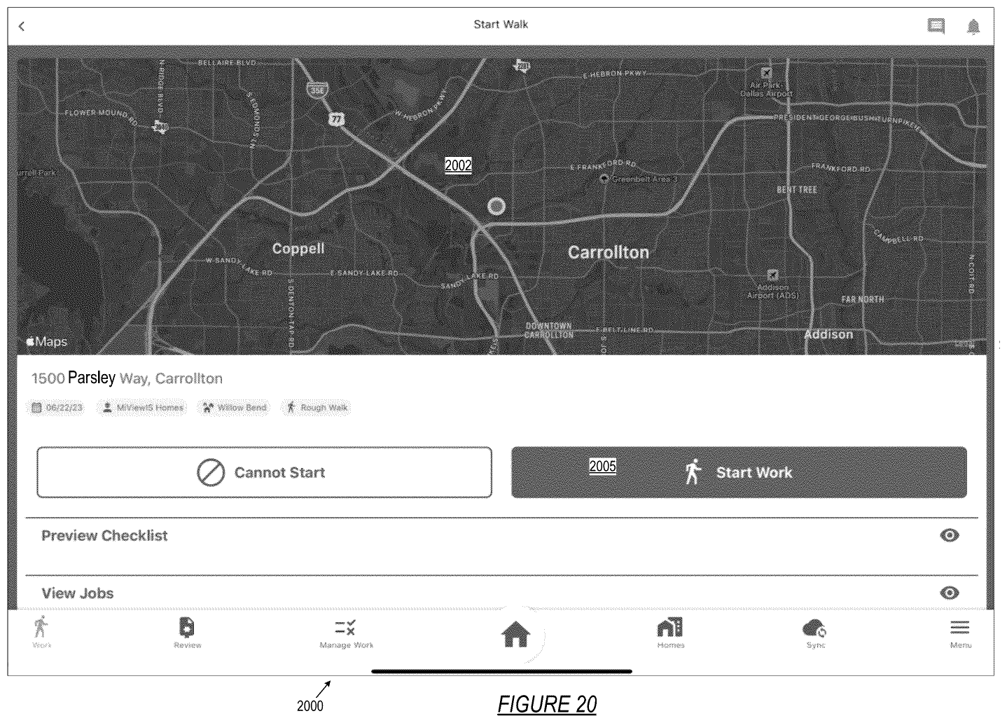

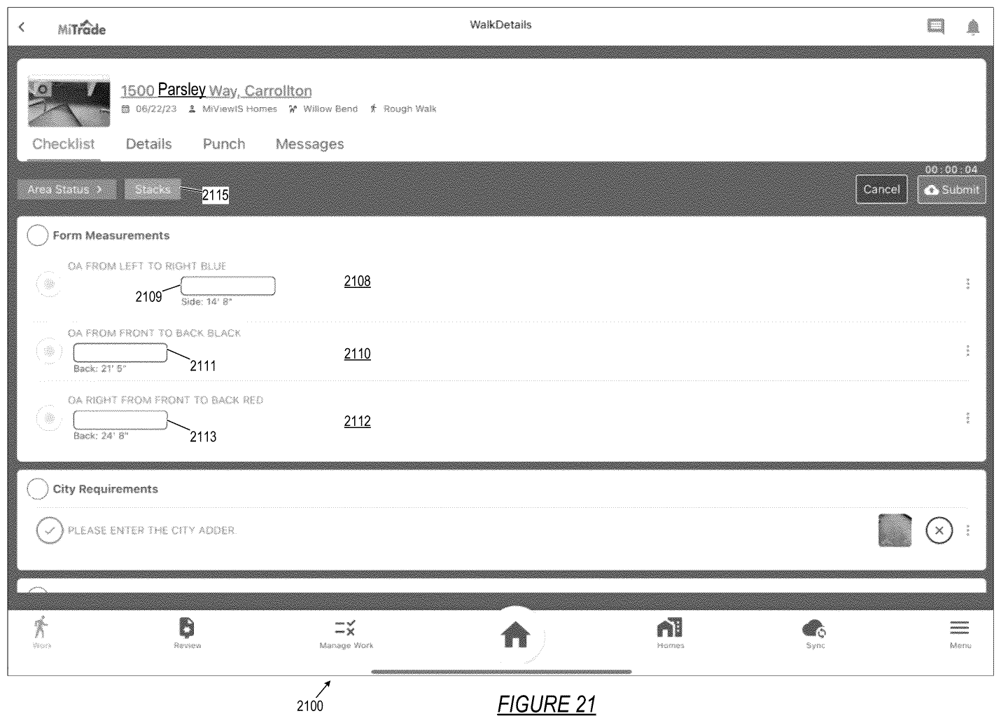

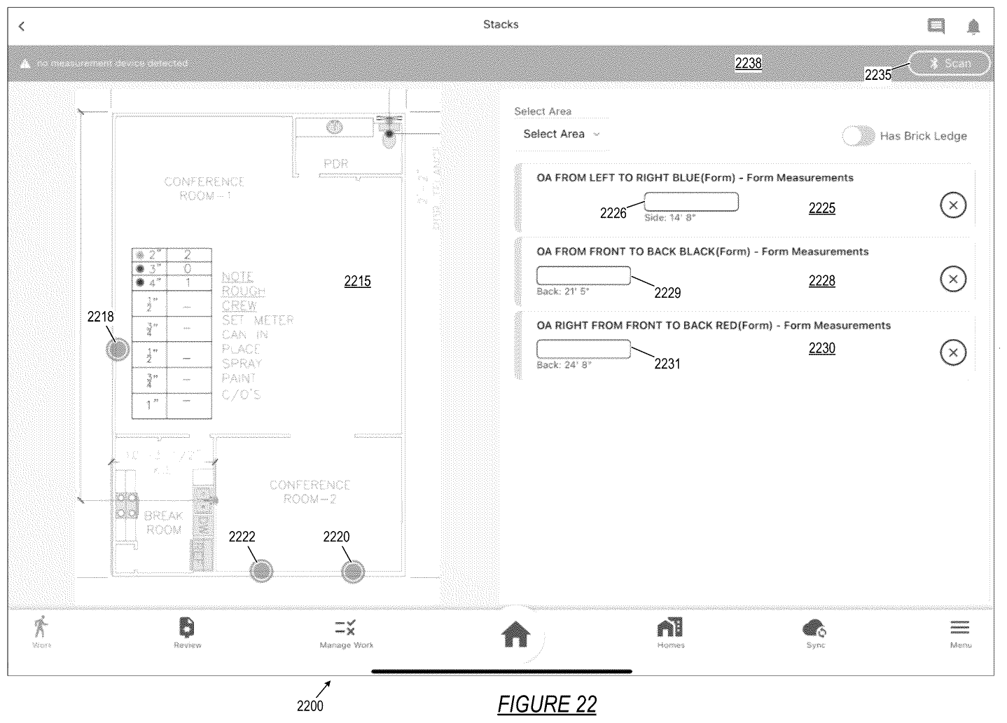

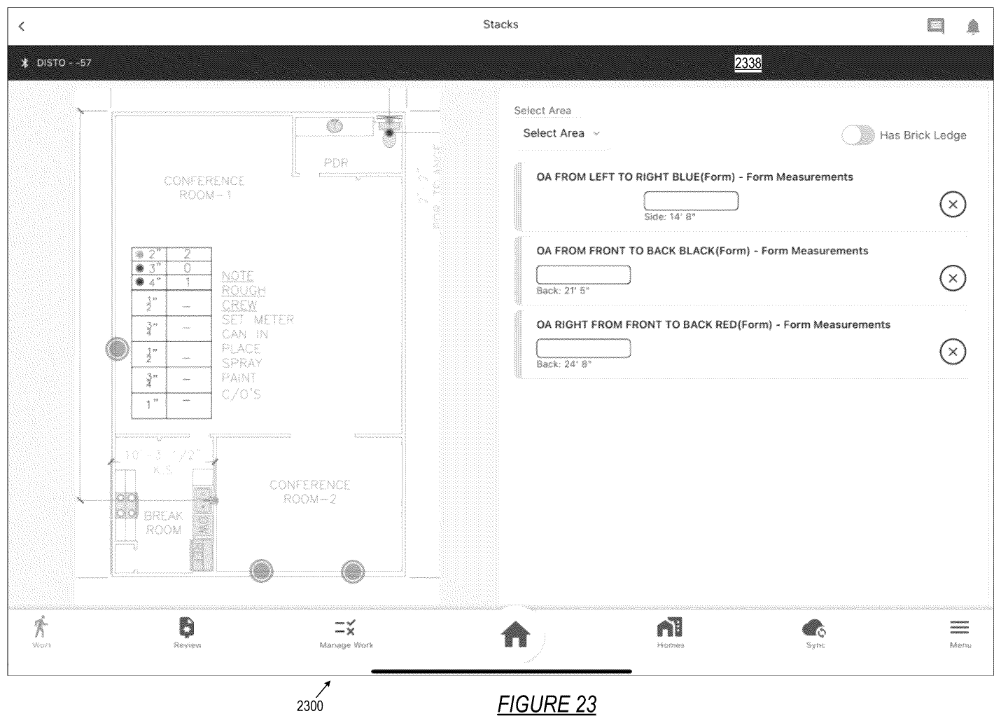

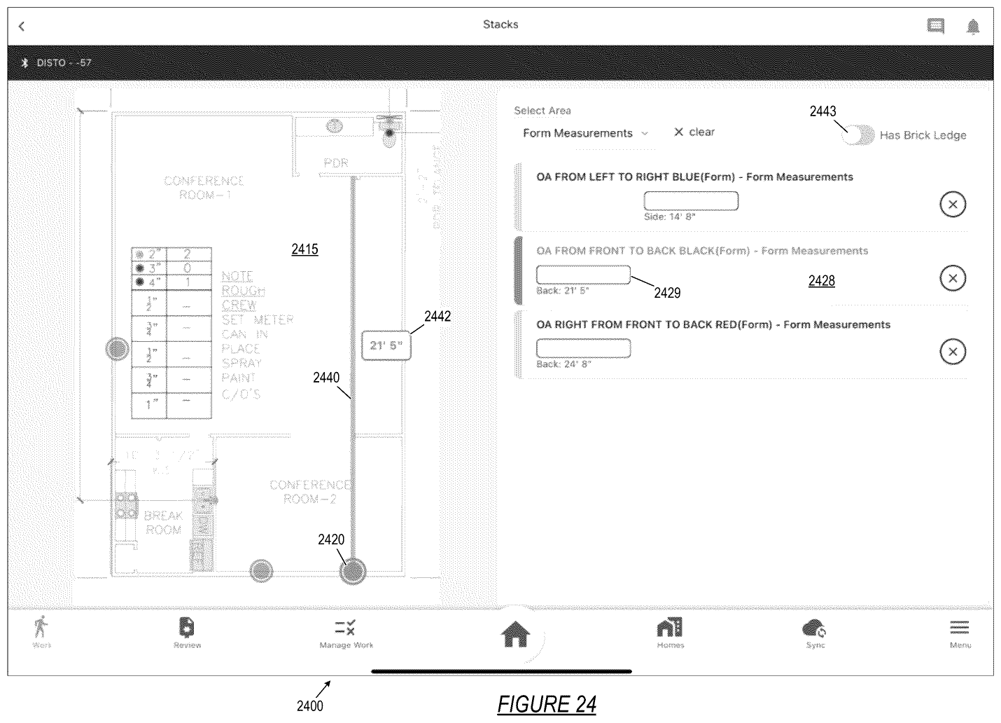

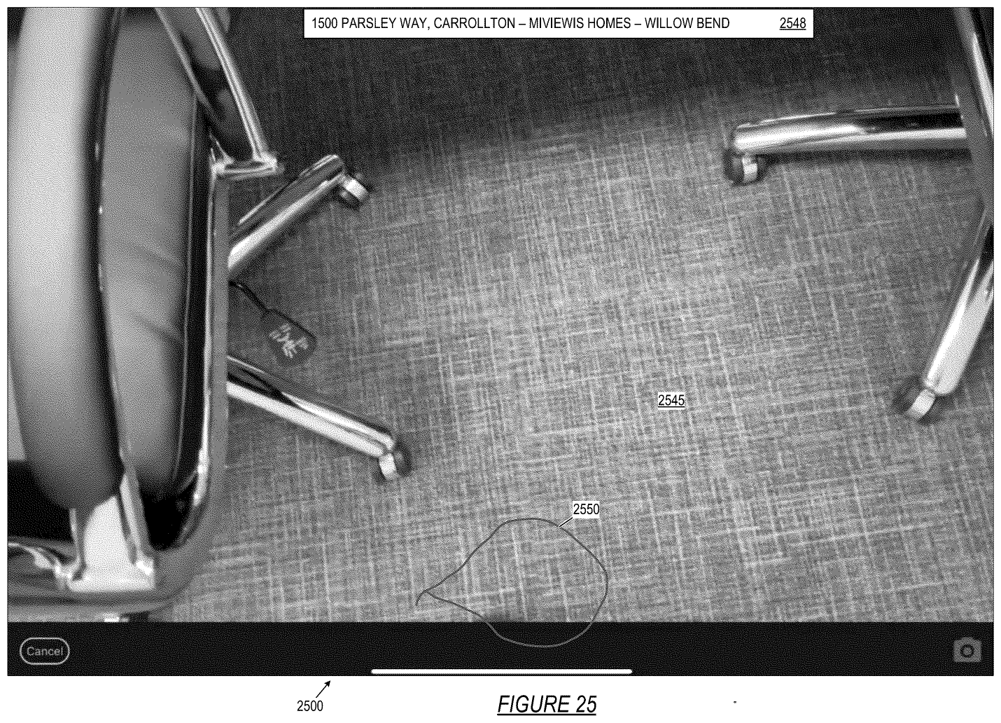

Turning to FIG. 6, the user interface (600) is displayed on a user device (e.g., a personal computer). The user interface (600) is an administrative interface that may be used to add measurement records to a worksite record. The worksite is identified with an address (“1500 Parsley Way, Carrollton, TX”). Additional information about the worksite indicates that the worksite is part of the “Willow Bend” community, is run by a builder named “MiViewIS Homes”, has a zip code of “75007”, and that the plan for the worksite is “Rough” (corresponding to the “Rough In” interface element of the interface elements (602)).

The interface elements (602) may be selected to identify a stage of construction. The stages include “Rough In”, “Box and Wrap”, “Top Out”, and “Trim”; other stages may be used. For different trades (e.g., electrical, heating and air, etc.) the system may be configured to use different labels for the stages of construction.

Turning to FIG. 7, the user interface (700) is displayed on a user device. The user interface (700) illustrates a viewing program for a design file (named “CUSTOM CAD-Rough.pdf”). The cropped portion (702) of the view of the design file is the portion of the view of the design file that forms the design image used by the system.

Turning to FIG. 8, the user interface (800) is displayed on a user device. The user interface (800) illustrates the design image (802) that is part of the worksite record for the “Rough In” stage. In an embodiment, the design image (802) corresponds to the cropped portion (702) from FIG. 7. The design image (802) is displayed in the design view (805). The measurement list view (808) includes several blank items that may be filled in to identify measurements to be taken at the worksite identified in the user interface (800). For example, the interface element (810) may be selected to add a checklist item to the item of the interface element (809) titled “Form Measurements”. The interface element (812) may be selected to add measurements to the item of the interface element (809) titled “Form Measurements”. The interface element (812) is labeled “stack” to indicate that the measurement added may be for a stack. Different embodiments may be configured with a different label for the interface element (812) to add a measurement, which may be for an item that is not a stack.

Turning to FIG. 9, the interface element (915) is displayed after selection of the interface element (812) of FIG. 8. The interface element (915) is a dialogue box used to import stack information from a file, e.g., the file named “CUSTOM CAD2 dwg.CSV”. In an embodiment, the file from which the values for the stack measurements are imported is a file storing data in a tabular format, such as a comma separated value (CSV) file. Other formats may be used. After identifying the file the user may select the button identified as “import” to import information about stacks to be measured at the worksite.

Turning to FIG. 10, the contents of the files (1018) and (1020) are illustrated. The system may process the original design file to extract the information in the files (1018) and (1020).

The files (1018) and (1020) are CSV files. Each row includes a label extracted from the original design file. The files (1018) and (1020) may include multiple labels. Multiple labels may correspond to a single measurement.

Turning to FIG. 11, the user interface (1100) is displayed after information for multiple boundaries and measurement points have been imported from the file (1020) of FIG. 10. The user interface (1100) includes the views (1122), (1105), and (1108) that are updated based on information from the file (1020). The interface element (1121) is updated to include an icon with a number that identifies the number of measurements for the stage (“Rough In”) identified with the interface element (1121).

The view (1122) includes a list of interface elements with information about the boundaries used for measurements. Information for three boundaries is included in the interface elements (1125), (1128), and (1130), which correspond to three boundary records. The boundaries are color coded red, black, and blue, respectively, within the interface elements (1125), (1128), and (1130).

The interface elements (1125), (1128), and (1130) include additional interface elements. The additional interface elements collect and display information about a boundary.

Within the interface element (1125), the element named “brick ledge”, is a checkbox. The element named “brick ledge” in the interface element (1125) identifies if the boundary corresponds to a brick ledge. When true, the verification of the measurements against the boundary of the interface element (1125) may be adjusted to account for the boundary being related to a brick ledge. In an embodiment, the amount of the adjustment may be 4 inches.

Within the interface element (1125), the element named “offset”, is an edit box. The element named “offset” records an additional offset used in the verification of measurements against the boundary of the interface element (1125).

The view (1105) is updated to include graphical depictions of the boundaries. The line (1132) corresponds to the boundary coded with the color black and the interface element (1128). The line (1135) corresponds to the boundary coded with the color blue and the interface element (1130).

The view (1108) is updated to include the interface elements (1138), (1140), and (1142) underneath the interface element (1109). The interface elements (1138), (1140), and (1142) correspond to the rows from the file (1020) of FIG. 10.

The interface element (1138) includes information about a measurement record for a measurement to be taken at the worksite. Information in the interface element (1138) includes a name (“OA FROM LEFT TO RIGHT BLUE”), a stage identification (“Rough”), a first measurement (“Back-Red 0″”, i.e., 0 inches), a second measurement (“Right-Blue: 14′-5″”, i.e., 14 feet, 5 inches), and a size (“Size: Form”). The first measurement of “0” indicates that this measurement may be skipped. The interface elements (1140) and (1142) include similar information.

Turning to FIG. 12, the user interface is updated after selecting the interface element (1140) from FIG. 11. The interface element (1240) is between the interface elements (1238) and (1242). The interface element (1240) is expanded to include interface elements to collect and display information for a measurement record that corresponds to the interface element (1240).

The interface element (1245) provides for selection of the stage of construction (“Rough”). The interface element (1248) provides for selection of a boundary (“Back-Black”), which corresponds to the line (1232) and the interface element (1228). The interface element (1250) provides for collection of an expected distance (“21′-5″”) for a measurement, which is updated from interface element (1140) of FIG. 11. The interface element (1252) provides for collection of the tolerance value (“1″”) for a measurement.

The interface element (1255) provides for selection of a second boundary (“Right-Blue”), which is orthogonal to the boundary identified with the interface element (1248) and corresponds to the line (1235) and the interface element (1230). The interface element (1258) provides for collection of an expected distance (“0″”) for a measurement. The expected distance of “0″” indicates that a measurement is not to be taken. The interface element (1260) provides for collection of the tolerance value (“1″”) for a measurement.

Turning to FIG. 13, the user interface (1300) is updated after receiving adjustments to the lines (1326), (1332), and (1335). The lines (1326), (1332), and (1335) are located (e.g., by dragging) to correspond to the walls displayed in the design image (1302). The lines (1326), (1332), and (1335) correspond to the interface elements (1325), (1328), and (1330), respectively. The locations of the lines (1326), (1332), and (1335) may be recorded to boundary records for the interface elements (1325), (1328), and (1330), respectively.

Turning to FIG. 14, the user interface (1400) is updated from the user interface (1300) of FIG. 13. The interface element (1438) is selected and then the location for the interface element (1462) is identified for a measurement point. The interface element (1462) is an icon that is a dot that identifies the location of the measurement point at the worksite on the design image (1402) where the measurement device should be placed to take a measurement for the measurement record corresponding to the interface element (1438). The measurement is between the physical location at the worksite that corresponds to the dot (i.e., to the interface element (1462)) and the line (1435) (the “Right-Blue” boundary). The expected distance is identified as “14′-5″” from the interface element (1465). The location of the interface element (1462) may be saved with selection of the interface element (1468), which is a save button.

Turning to FIG. 15, the user interface (1500) is updated from the user interface (1400) of FIG. 14. The user interface (1500) is updated after selecting the interface element (1468) of FIG. 14 to save the location of the measurement point identified by the interface element (1562). The interface element (1562) is updated from the interface element (1462) of FIG. 14 by changing the color from blue to grey to indicate that the location of the measurement point has been saved to the measurement record.

The interface element (1538) is updated from the interface element (1438) of FIG. 14. The interface element (1538) is updated by collapsing down. The interface element (1572) is updated by changing color from orange to green. The orange color indicates that the measurement point (i.e., the interface element (1562) has not been located.

The interface element (1521) is updated. The numerical indicator in the interface element is changed from “3” to “2” to indicate that two more measurement points have not been located on the design image (1502).

Turning to FIG. 16, the user interface (1600) is updated from the user interface (1500) of FIG. 15. The user interface (1600) is updated to select the interface element (1640). The user interface (1600) is further updated to identify the location of another measurement point with the placement of the interface element (1670).

Turning to FIG. 17, the user interface (1700) is updated from the user interface (1600) of FIG. 16. The user interface (1700) is updated to collapse the interface element (1740) and change a color of the interface element (1740) from orange to green. The user interface (1700) is further updated to change the color of the interface element (1770) from blue to grey to indicate that the measurement point is saved.

Turning to FIG. 18, the user interface (1800) from the user interface (1700) of FIG. 17. The user interface (1700) is updated to select the interface element (1842). The user interface (1800) is further updated to identify the location of another measurement point with the placement of the interface element (1872).

Turning to FIG. 19, the user interface (1900) is updated from the user interface (1800) of FIG. 18. The user interface (1900) is updated to collapse the interface element (1942) and change a color of the interface element (1942) from orange to green. The user interface (1900) is further updated to change the color of the interface element (1972) from blue to grey to indicate that the measurement point is saved.

Turning to FIG. 20, the user interface (2000) is displayed on a worker interface. The user of the worker interface may be a supervisor taking measurements to check the work performed at the worksite. The user interface (2000) includes several interface elements, including the interface elements (2002) and (2005). The interface element (2002) displays a map that includes the location of the worksite. The user interface element (2005) is a button to initiate work on a checklist for the worksite.

Turning to FIG. 21, the user interface (2100) is updated from the user interface element (2000) of FIG. 20. The user interface (2100) is updated to display interface elements of a checklist with several items. The interface elements (2108), (2110), and (2112) collect information for measurement points. The user interface elements (2108), (2110), and (2112) include the interface elements (2109), (2111), and (2113), respectively. The interface elements (2109), (2111), and (2113) are color coded to different measurement points. The interface elements (2111) and (2113) are aligned in a first column and the interface element (2109) is aligned in a second column. The first column identifies measurements that are from front to back and the second column identifies measurements from left to right. Expected measurements for the interface elements (2108), (2110), and (2112) are displayed below the interface elements (2108), (2110), and (2112).

The is there interface (2100) further includes the interface element (2115). The interface element (2115) is a button labeled “Stacks” that, when selected, initiates collection of the measurements for the interface elements (2108), (2110), and (2112).

Turning to FIG. 22, the user interface (2200) is displayed after selection of the interface element (2115) of FIG. 21. The user interface (2200) displays the design image (2215) with the interface elements (2218), (2220), and (2222) to identify the location of measurement points that correspond to the interface elements (2226), (2229), and (2231). The interface elements (2225), (2228), and (2230) identify the measurements to be taken and recorded using the interface elements (2226), (2229), and (2231).

The user interface (2200) includes the interface element (2235). The interface element (2235) is a button that, upon selection, provides for connecting the user device to a measurement device to generate the measurements to be recorded in the interface elements (2226), (2229), and (2231). The interface element (2235) is displayed within the interface element (2238), which provides a notification that the user device is not presently connected to a measurement device.

Turning to FIG. 23, the user interface (2300) is updated from the user interface (2200) of FIG. 22. The interface element (2338) is updated to change colors from orange to dark blue to indicate that the user device is connected to an external measurement device. The interface element (2338) indicates that the measurement device is identified as “DISTO-57”.

Turning to FIG. 24, the user interface (2400) is updated after selection of one of the interface elements (2428) and (2420). The color of the interface element (2428) is updated to be blue to indicate selection of the interface element (2428).

The color of the interface element (2420) is also changed to be blue and the line (2440) is displayed on the design image (2415). The interface element (2442) is also displayed which includes text to identify the expected distance for the measurement.

The interface element (2443) may be used to indicate when a brick ledge is present at the worksite. When selected, an additional offset of 2 inches may be included (e.g., added or subtracted) from a measurement during verification to account for the thickness of the brick ledge.

Turning to FIG. 25, the user interface (2500) is displayed after successful verification of a measurement. The user interface (2500) includes the camera view (2545) with a live feed from the camera of the user device. The image in the camera view (2545) includes the overlay (2548) and the highlight (2550). In addition, one or more watermarks may be included to identify organizations related to the worksite.

The overlay (2548) includes information about the worksite, the information includes the physical location of the worksite (“1500 Parsley Way, Carrollton”), the name of the builder company (“MiViewIS Homes”), and the name of the community where the worksite is located (“Willow Bend”).

The camera view (2545) also includes the highlight (2550). The highlight (2550) will be integrated into the image when saved and identifies a portion of the image of interest. For example, a highlight of an image may identify an item for which a measurement is being taken, e.g., a stack.

Turning to FIG. 26, the user interface (2600) is displayed after capturing an image of the worksite with the user interface (2500) of FIG. 25. The interface element (2620) is updated to display a check mark instead of a dot. The interface element (2642) is updated to include the measured distance (colored in orange and in bold) in addition to the expected distance (colored in blue without bold).

The interface element (2628) is updated to include the measured distance (“21′ 5″”) in the interface element (2629) and include the thumbnail image (2645) generated from the image captured with the camera view (2545) of FIG. 25.

Turning to FIG. 27, the user interface (2700) is updated from the user interface (2600) of FIG. 26. The interface element (2725) is displayed with the color grey. The interface element (2728) is updated to be displayed with the color green to indicate that the measurement has been taken and verified. The interface element (2730) is updated to be displayed with the color blue to indicate but the next measurement taking the measurement device will be applied to the interface element (2730).

The interface element (2720) is updated from the interface element (2620) of FIG. 26 to be displayed in green instead of blue to indicate that the measurement was successfully verified. The interface element (2752) is displayed in blue instead of grey to identify the measurement point for the next measurement. The line (2755) identifies the length to be measured. The interface element (2758) includes the expected distance (“24′ 8″”) for the next measurement.

Turning to FIG. 28, the user interface (2800) is updated from the user interface (2700) of FIG. 27. The user interface (2800) is updated after a measurement is taken and verified.

The interface element (2852) is updated to display a check mark instead of a dot. The interface elements (2858) and (2830) are updated to include the measured distance (“24′ 8″”). The interface element (2830) also includes a thumbnail of the image captured at the worksite for the measurement.

Turning to FIG. 29, the user interface (2900) is updated from the user interface (2800) of FIG. 28. The interface element (2952) is updated to be colored green instead of blue to indicate successful verification. The interface element (2962) is updated to be colored blue instead of grey to identify the next measurement point to be measured. The line (2960) identifies the length and direction of the next measurement. The interface element (2965) identifies the expected distance (“14′ 8″”) for the next measurement.

The interface element (2930) is updated to display the left accent color as green instead of blue, and the font as black instead of blue to indicate that the measurement is completed. The interface element (2925) is updated to be displayed with a blue left accent and blue font to indicate that the next measurement will be applied to the interface element (2925).

Turning to FIG. 30, the user interface (3000) is updated after collecting a measurement that did not pass verification. The interface element (3065) and the interface element (3025) are updated to include the measured distance “10′ 5½″”, which does not validate with the expected distance of “14′ 8″”.

Turning to FIG. 31, the user interface (3100) is updated to display the interface element (3168). The interface element (3168) includes interface elements for a user to override the lack of validation or add a punch. The validation may be overridden using the button labeled “Complete Stack”. A punch may be added using the button labeled “Add Punch”, which may bring up a series of dialog boxes to identify additional work to perform at the worksite.

Turning to FIG. 32, the user interface (3200) is updated from the user interface (3100) of FIG. 31 after selecting the button labeled “Cancel” and capturing a measurement that validates with the expected distance and tolerance value. The interface element (3262) is updated to include a check mark. The interface elements (3265) and (3225) are updated to include the measurement distance “14′ 7½″”.

Turning to FIG. 33, the user interface (3300) may be displayed on a worker interface after measurements have been captured. The user interface (3300) displays a checklist with items for measurements. The interface elements (3302), (3305), and (3308) each include a measured distance and a thumbnail image.

Turning to FIG. 34, the user interface (3400) includes a checklist that is updated from the user interface (3300) FIG. 33. The user interface element (3402) is updated after an additional picture is taken. The thumbnail image (3410) is updated with the latest image captured and is updated to include a notification with the number (2) to indicate the number of pictures for the interface element (3402).

The user interface (3400) also includes the interface element (3412). The interface element (3412) is a button with the label “Submit”. Selection of the interface element (3412) may be performed after completion of all the items in the checklist displayed in the user interface (3400).

Turning to FIG. 35, the user interface (3050) is displayed after selection of the interface element (3412) of the user interface (3400) of FIG. 34 after the checklist items have been addressed. The interface element (3515) is a signature window used to capture a signature of the user of the device to signify the approval by the user of the completion of the checklist. The interface element (3518) is a button used to confirm verification of the signature in the interface element (3515) and the completion of the checklist of the user interface (3400) of FIG. 34.

Turning to FIG. 36, the user interface (3600) the displayed after selection of the interface element (3518) of FIG. 35. The interface element (3620) identifies the worksite corresponding to the checklist from the user interface (3400) of FIG. 34. The interface element (3620) includes a progress bar displayed as green and a green check mark icon to indicate completion of the checklist corresponding to the interface element (3620).

The interface element (3622) corresponds to a different checklist. The interface element (3622) includes a progress bar displayed in blue that is indicated as “83%” complete. The interface element (3622) further includes an orange clock icon on a left side to indicate that the checklist corresponding to the interface element (3622) is not complete.

Turning to FIG. 37, the user interface (3700) displays a measurement capture view for a measurement point for which two measurements are to be taken. The measurement point corresponds to the location of the interface element (3702), which is displayed as a blue dot icon on the design image (3712). The lines (3705) and (3708) extend from the location of the interface element (3702) to indicate the direction used to take the measurements related to the lines (3705) and (3708), which correspond to the interface elements (3722) and (3725), respectively.

The interface element (3706) displays the expected distance “5′ 9″” colored blue without bold font for the measurement corresponding to the line (3705) and the interface element (3722). The interface element (3709) displays the expected distance “5′ 2″” colored blue without bold font for the measurement corresponding to the line (3705) and the interface element (3725).

The interface element (3720) identifies the two measurements to be taken with the interface elements (3722) and (3725). The interface element (3722) corresponds to a measurement that is portrayed as vertical on the design image (3712). The interface element (3725) corresponds to a measurement that is portrayed as horizontal on the design image (3712).

Turning to FIG. 38, the user interface (3800) is updated from the user interface (3700) of FIG. 37. The interface elements (3806) and (3822) are updated to include the measured distance “5′ 9″” that has been verified to be within the tolerance value of the expected distance. The interface element (3806) displays the measured distance “5′ 9″” colored orange with bold font.

Turning to FIG. 39, the user interface (3900) is updated from the user interface (3800) of FIG. 38. The interface elements (3909) and (3925) are updated to include the measured distance “5′ 2¾″” that has been verified to be within the tolerance value of the expected distance. The interface element (3909 displays the measured distance “5′ 2¾″” colored orange with bold font.

The interface element (3920) is updated to include the thumbnail (3928). The thumbnail (3928) is generated from an image captured by the user device after measurements for both measurement points are completed.

Turning to FIG. 40, the user interface (4000) is displayed after the measurements taken with the user interface (3900) of FIG. 39 are completed. The user interface (4000) includes a checklist with the interface element (4020) representing an item of the checklist. The interface element (4020) displays the measured distances captured at the worksite with the measurement device and transmitted to the user device along with a thumbnail image generated from an image captured with the user device at the worksite.

Embodiments of the disclosure may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 41A, the computing system (4100) may include one or more computer processors (4102), non-persistent storage device(s) (4104), persistent storage device(s) (4106), a communication interface (4112) (e.g., Bluetooth interface, infrared interface, network interface, optical interface, etc.), and numerous other elements and functionalities that implement the features and elements of the disclosure. The computer processor(s) (4102) may be an integrated circuit for processing instructions. The computer processor(s) may be one or more cores or micro-cores of a processor. The computer processor(s) (4102) includes one or more processors. The one or more processors may include a central processing unit (CPU), a graphics processing unit (GPU), a tensor processing (TPU), combinations thereof, etc.

The input devices (4110) may include a touchscreen, keyboard, mouse, microphone, touchpad, electronic pen, or any other type of input device. The input devices (4110) may receive inputs from a user that are responsive to data and messages presented by the output devices (4108). The inputs may include text input, audio input, video input, etc., which may be processed and transmitted by the computing system (4100) in accordance with the disclosure. The communication interface (4112) may include an integrated circuit for connecting the computing system (4100) to a network (not shown) (e.g., a local area network (LAN), a wide area network (WAN) such as the Internet, mobile network, or any other type of network) and/or to another device, such as another computing device.

Further, the output devices (4108) may include a display device, a printer, external storage, or any other output device. One or more of the output devices may be the same or different from the input device(s). The input and output device(s) may be locally or remotely connected to the computer processor(s) (4102). Many different types of computing systems exist, and the aforementioned input and output device(s) may take other forms. The output devices (4108) may display data and messages that are transmitted and received by the computing system (4100). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (4100) in FIG. 41A may be connected to or be a part of a network. For example, as shown in FIG. 41B, the network (4120) may include multiple nodes (e.g., node X (4122), node Y (4124)). Each node may correspond to a computing system, such as the computing system shown in FIG. 41A, or a group of nodes combined may correspond to the computing system shown in FIG. 41A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (4100) may be located at a remote location and connected to the other elements over a network.

The nodes (e.g., node X (4122), node Y (4124)) in the network (4120) may be configured to provide services for a client device (4126), including receiving requests and transmitting responses to the client device (4126). For example, the nodes may be part of a cloud computing system. The client device (4126) may be a computing system, such as the computing system shown in FIG. 41A. Further, the client device (4126) may include and/or perform all or a portion of one or more embodiments.

The computing system of FIG. 41A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user (e.g., data presented as actual data values through text) or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
presenting a view to a user device, wherein the view comprises a design image corresponding to a worksite, wherein the design image comprises a measurement point;
receiving a measurement signal;
applying a measurement model to the measurement signal to create a measured distance corresponding to the measurement point;
applying a verification model to the measured distance to create a verification signal; and
automatically updating the view to an updated view based on the verification signal, wherein the updated view comprises an updated image, wherein the updated image comprises the measured distance.

2. The method of claim 1, further comprising:
automatically presenting a camera view responsive to the verification signal indicating a successful verification;
receiving a worksite image captured with a user device, wherein the worksite image is captured at the worksite, wherein the worksite image comprises at least one watermark embedded within the worksite image, at least one highlight overlaid onto the worksite image, and worksite text overlaid onto the worksite image; and
presenting a worksite thumbnail generated from the worksite image in the updated view.

3. The method of claim 1, further comprising:
automatically presenting a confirmation view responsive to the verification signal indicating an unsuccessful verification.

4. The method of claim 1, further comprising:
receiving a second measurement signal from a measurement device;
applying the measurement model to the second measurement signal to generate a second measured distance;
applying a second verification model to the second measured distance to generate a second verification signal corresponding to the measurement point; and
automatically updating the view to the updated view, wherein the updated view comprises the measured distance and the second measured distance.

5. The method of claim 1, wherein presenting the view further comprises:
the image comprising an expected distance corresponding to the measurement point.

6. The method of claim 1, wherein presenting the view further comprises:
presenting the updated view comprising the updated image, wherein the updated image further comprises an expected distance and the measured distance.

7. The method of claim 1, further comprising:
the verification signal indicating that the measured distance is within a tolerance value of an expected distance.

8. The method of claim 1, further comprising:
the measurement signal comprising a capture angle and a capture distance; and
the verification model calculating the measured distance from the capture angle and the capture distance.

9. The method of claim 1, further comprising:
presenting a task item of a task checklist, wherein the task item is automatically updated based on the verification signal, wherein the task item is presented with a worksite thumbnail generated from a worksite image captured at the worksite.

10. The method of claim 1, further comprising:
presenting a worksite item of a worksite checklist;
applying a completion model to the worksite item to generate a completion signal; and
automatically updating the worksite item to an updated worksite item based on the completion signal.

11. A system comprising:
at least one processor;
an application executing on the at least one processor to perform:
presenting a view to a user device, wherein the view comprises a design image corresponding to a worksite, wherein the design image comprises a measurement point;
receiving a measurement signal;
applying a measurement model to the measurement signal to create a measured distance corresponding to the measurement point;
applying a verification model to the measured distance to create a verification signal; and
automatically updating the view to an updated view based on the verification signal, wherein the updated view comprises an updated image, wherein the updated image comprises the measured distance.

12. The system of claim 11, wherein the application further performs:
automatically presenting a camera view responsive to the verification signal indicating a successful verification;
receiving a worksite image captured with a user device, wherein the worksite image is captured at the worksite, wherein the worksite image comprises at least one watermark embedded within the worksite image, at least one highlight overlaid onto the worksite image, and worksite text overlaid onto the worksite image; and
presenting a worksite thumbnail generated from the worksite image in the updated view.

13. The system of claim 11, wherein the application further performs:
automatically presenting a confirmation view responsive to the verification signal indicating an unsuccessful verification.

14. The system of claim 11, wherein the application further performs:
receiving a second measurement signal from a measurement device;
applying the measurement model to the second measurement signal to generate a second measured distance;
applying a second verification model to the second measured distance to generate a second verification signal corresponding to the measurement point; and
automatically updating the view to the updated view, wherein the updated view comprises the measured distance and the second measured distance.

15. The system of claim 11, wherein presenting the view further comprises:
the image comprising an expected distance corresponding to the measurement point.

16. The system of claim 11, wherein presenting the view further comprises:
presenting the updated view comprising the updated image, wherein the updated image further comprises an expected distance and the measured distance.

17. The system of claim 11, wherein the application further performs:
the verification signal indicating that the measured distance is within a tolerance value of an expected distance.

18. The system of claim 11, wherein the application further performs:
the measurement signal comprising a capture angle and a capture distance; and
the verification model calculating the measured distance from the capture angle and the capture distance.

19. The system of claim 11, wherein the application further performs:
presenting a task item of a task checklist, wherein the task item is automatically updated based on the verification signal, wherein the task item is presented with a worksite thumbnail generated from a worksite image captured at the worksite.

20. A non-transitory computer readable medium comprising instructions that, when executed on at least one processor, perform:
presenting a view to a user device, wherein the view comprises a design image corresponding to a worksite, wherein the design image comprises a measurement point;
receiving a measurement signal;
applying a measurement model to the measurement signal to create a measured distance corresponding to the measurement point;
applying a verification model to the measured distance to create a verification signal; and
automatically updating the view to an updated view based on the verification signal, wherein the updated view comprises an updated image, wherein the updated image comprises the measured distance.
